(19) United States
(12) Patent Application Publication
(10) Pub. No.: US 2021/0188678 A1
(43) Pub. Date: Jun. 24, 2021

(54) SYSTEMS AND METHODS FOR PURIFYING AQUEOUS SOLUTIONS

(71) Applicant: Colorado State University Research Foundation, Fort Collins, CO (US)

(72) Inventors: Zuoyou Zhang, Fort Collins, CO (US); Xuewei Du, Fort Collins, CO (US); Kenneth H. Carlson, Fort Collins, CO (US); Cristian A. Robbins, Fort Collins, CO (US); Tiezheng Tong, Fort Collins, CO (US)

(21) Appl. No.: 17/124,891

(22) Filed: Dec. 17, 2020

Related U.S. Application Data
(60) Provisional application No. 62/950,760, filed on Dec. 19, 2019.

(51) Int. Cl. C02F 9/00

(52) U.S. Cl. CPC C02F 9/00; C02F 2103/10

(57) ABSTRACT

Disclosed herein are systems and methods for purifying contaminated aqueous solutions. The methods comprise subjecting the contaminated aqueous solution to a first pretreatment comprising coagulation or precipitative softening; a second pretreatment comprising adsorptive filtration; and a membrane distillation, in that order, to form a purified aqueous solution. The systems comprise a first pretreatment component fluidly connected to a second pretreatment component fluidly connected to a membrane distillation component, in that order, wherein the systems are configured to perform the methods disclosed herein.

### CROSS-REFERENCE TO RELATED APPLICATIONS

This application claims the benefit of priority to U.S. Provisional Application No. 62/950,760 filed Dec. 19, 2019, which is hereby incorporated herein by reference in its entirety.

### BACKGROUND

The application of horizontal drilling and high-volume hydraulic fracturing techniques has expanded the extraction of hydrocarbon resources from unconventional oil and gas reservoirs in the U.S. The boom of the shale oil and gas industry has not only enhanced the energy security of the U.S., but has also disrupted the oil and gas markets by driving down prices worldwide. However, shale oil and gas production consumes large amounts of fresh water and produces a substantial volume of hazardous wastewater, creating a dual challenge of water scarcity and pollution at the water-energy nexus. Current wastewater management options, including deep-well injection and direct discharge into surface water or publicly owned treatment works (POTWs), are either impractical or limited due to the adverse impacts on natural water resources, expensive disposal costs, as well as geological and legal restrictions. Effective and economically feasible wastewater treatment technologies, therefore, are needed to improve the sustainability and viability of the shale oil and gas industry. The systems and methods described herein address these and other needs.

### SUMMARY

In accordance with the purposes of the disclosed systems and methods, as embodied and broadly described herein, the disclosed subject matter relates to systems and methods for purifying contaminated aqueous solutions. For example, disclosed herein are systems and methods for wastewater treatment, such as treatment of shale oil and gas produced water.

Disclosed herein are methods for purifying a contaminated aqueous solution to form a purified aqueous solution; the contaminated aqueous solution comprising a particulate contaminant, an inorganic contaminant, an organic contaminant, or a combination thereof; the methods comprising:

subjecting the contaminated aqueous solution to a first pretreatment comprising coagulation or precipitative softening to form an initial partially purified aqueous solution; wherein:

when the first pretreatment comprises coagulation, subjecting the contaminated aqueous solution to the first pretreatment comprises: contacting the contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separating the supernatant from the coagulated phase; and collecting the supernatant; wherein the supernatant is the initial partially purified aqueous solution; and

when the first pretreatment comprises precipitative softening, subjecting the contaminated aqueous solution to the first pretreatment comprises: contacting the contaminated aqueous solution with an acid or a base to adjust the pH of the contaminated aqueous solution, thereby forming a pH adjusted contaminated aqueous solution; contacting the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separating the supernatant from the coagulated phase; and collecting the supernatant; wherein the supernatant is the initial partially purified aqueous solution;

subjecting the initial partially purified aqueous solution to a second pretreatment comprising adsorptive filtration to form an intermediate partially purified aqueous solution;

wherein subjecting the initial partially purified aqueous solution to the second pretreatment comprises: introducing the initial partially purified aqueous solution as an influent to a filter column packed with an adsorbent filter media such that the initial partially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and collecting an effluent from the filter column, wherein the effluent is the intermediate partially purified aqueous solution; and

subjecting the intermediate partially purified aqueous solution to membrane distillation to form the purified aqueous solution;

wherein subjecting the intermediate partially purified aqueous solution to membrane distillation comprises: distilling the intermediate partially purified aqueous solution through a porous distillation membrane thereby producing a distillate; and collecting the distillate; wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and wherein the distillate is the purified aqueous solution.

Also disclosed herein are systems for purifying a contaminated aqueous solution to form a purified aqueous solution; the contaminated aqueous solution comprising a particulate contaminant, an inorganic contaminant, an organic contaminant, or a combination thereof; the systems comprising:

a first pretreatment component configured to receive a contaminated aqueous solution and subject the contaminated aqueous solution to a first pretreatment comprising coagulation or precipitative softening to form an initial partially purified aqueous solution; wherein:

when the first pretreatment comprises coagulation, the first pretreatment component is configured to: contact the contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separate the supernatant from the coagulated phase; and collect the supernatant; wherein the supernatant is the initial partially purified aqueous solution; and

when the first pretreatment comprises precipitative softening, the first pretreatment component is configured to: contact the contaminated aqueous solution with an acid or a base to adjust the pH of the contaminated aqueous solution, thereby forming a pH adjusted contaminated aqueous solution; contact the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separate the supernatant from the coagulated phase; and collect the supernatant; wherein the supernatant is the initial partially purified aqueous solution;

a second pretreatment component fluidly connected to the first pretreatment component, wherein the second pretreatment component is configured to receive the initial partially purified aqueous solution from the first pretreatment component and subject the initial partially purified aqueous solution to a second pretreatment comprising adsorptive filtration to form an intermediate partially purified aqueous solution;

wherein the second pretreatment component is configured to: introduce the initial partially purified aqueous solution as an influent to a filter column packed with an adsorbent filter media such that the initially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and collect an effluent from the filter column, wherein the effluent is the intermediate partially purified aqueous solution; and

a membrane distillation component fluidly connected to the second pretreatment component, wherein the membrane distillation component is configured to receive the intermediate partially purified aqueous solution from the second pretreatment component and subject the intermediate partially purified aqueous solution to membrane distillation to form the purified aqueous solution;

wherein the membrane distillation component is configured to: distill the intermediate partially purified aqueous solution through a porous distillation membrane thereby producing a distillate; and collect the distillate; wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and wherein the distillate is the purified aqueous solution.

Additional advantages of the disclosed systems and methods will be set forth in part in the description which follows, and in part will be obvious from the description. The advantages of the disclosed systems and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### DESCRIPTION OF FIGURES

The accompanying figures, which are incorporated in and constitute a part of this specification, illustrate several aspects of the disclosure, and together with the description, serve to explain the principles of the disclosure.

FIG. 1. Schematic of pretreatment procedure prior to membrane distillation of shale oil and gas produced water. The raw wastewater goes through precipitative softening (PS, with 30 min settling time) and walnut shell filtration (WSF) in sequence. The improvement of water quality is visible as indicated by the decrease of produced water turbidity.

FIG. 2. Precipitative softening performance with different doses of Al₂(SO₄)₃.18H₂O at pH=10 and room temperature (after 30 min settling time). From left to right: 0, 5, 10, 15, 20 mg/L of Al₂(SO₄)₃.18H₂O. 15 mg/L of Al₂(SO₄)₃.18H₂O was selected for the treatment train because it resulted in the lowest turbidity of the supernatant after precipitative softening.

FIG. 3. Normalized water (vapor) flux (left axis, circular data points) and permeate conductivity (right axis, square data points) during single-cycle direct contact membrane distillation desalination of shale oil and gas produced water with and without pretreatment. Precipitative softening (PS) and walnut shell filtration (WSF) improved the performance of downstream direct contact membrane distillation significantly. The crossflow velocities in the feed and distillate streams were 8.5 cm/s and 7.4 cm/s, respectively. The feed and distillate temperatures were 60° C. and 20° C., respectively. The feed volume was 2000 mL. The initial water fluxes for treating raw wastewater (WW), wastewater after precipitative softening only (PS only), and wastewater after precipitative softening and walnut shell filtration (PS+WSF) were 30.48, 30.06, and 31.38 L m⁻² h⁻¹, respectively.

FIG. 4. The conductivity at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 5. The concentration of dissolved boron at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 6. The concentration of total recoverable petroleum hydrocarbons (TRPH) at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 7. The concentration of total volatile petroleum hydrocarbons (TVPH) at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 8. The concentration of benzene at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 9. The concentration of toluene at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 10. The concentration of ethylbenzene at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 11. The concentration of total xylenes at different stages of shale oil and gas produced water treatment: (1) raw wastewater (WW), (2) raw wastewater after precipitative softening only, (3) raw wastewater after precipitative softening and walnut shell filtration; (4) direct contact membrane distillation product when using water (1) as the feed solution, (5) direct contact membrane distillation product when using water (2) as the feed solution, (6) direct contact membrane distillation product when using water (3) as the feed solution.

FIG. 12. Fouling reversibility and membrane reusability during direct contact membrane distillation desalination of shale oil and gas produced water pretreated by precipitative softening and walnut shell filtration. The experimental condition of direct contact membrane distillation desalination was identical to that described in FIG. 3, and the arrows indicate the time when the direct contact membrane distillation tests were terminated and the membrane coupons were subjected to physical cleaning followed by in-air drying. The dried membrane was then re-inserted into the direct contact membrane distillation system to start another cycle of desalination with new pretreated produced water.

FIG. 13. Schematic description of an on-site and mobile treatment package tailored to shale oil and gas production, utilizing the treatment chain composed of precipitative softening, walnut shell filtration, and membrane distillation. CNG boiler stands for compressed natural gas boiler.

FIG. 14. Membrane distillation performance for the treatment of unconventional oil and gas wastewater collected from Denver-Julesburg Basin using polyvinylidene fluoride membrane without pretreatment. Circular data points relate to the normalized water (vapor) flux (left axis) and square data points related to the permeate conductivity (right axis).

FIG. 15. Membrane distillation performance for the treatment of unconventional oil and gas wastewater collected from Denver-Julesburg Basin using polyvinylidene fluoride membrane with coagulation pretreatment. Circular data points relate to the normalized water (vapor) flux (left axis) and square data points related to the permeate conductivity (right axis).

FIG. 16. Membrane distillation performance for the treatment of unconventional oil and gas wastewater collected from Denver-Julesburg Basin using polyvinylidene fluoride membrane with coagulation and walnut shell filtration pretreatment. Circular data points relate to the normalized water (vapor) flux (left axis) and square data points related to the permeate conductivity (right axis).

### DETAILED DESCRIPTION

The systems and methods described herein may be understood more readily by reference to the following detailed description of specific aspects of the disclosed subject matter and the Examples included therein.

Before the present systems and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Disclosed herein are systems and methods for purifying contaminated aqueous solutions to form purified aqueous solutions.

The contaminated aqueous solution can comprise any type of water, treated or untreated. For example, the contaminated aqueous solution can comprise hard water, hard brine, sea water, brackish water, fresh water, flowback or produced water, wastewater (e.g., reclaimed or recycled), river water, lake or pond water, aquifer water, brine (e.g. reservoir or synthetic brine), slickwater, or a combination thereof. In some examples, the contaminated aqueous solution can comprise hard water, hard brine, sea water, brackish water, flowback or produced water, wastewater (e.g., reclaimed or recycled), brine (e.g. reservoir or synthetic brine), slickwater, or a combination thereof.

In some examples, the contaminated aqueous solution can comprise wastewater, such as industrial wastewater and/or wastewater from unconventional energy production. In some examples, the contaminated aqueous solution can comprise wastewater from gas and/or oil production from a subterranean formation (e.g., unconventional formation, conventional formation). In some examples, the contaminated aqueous solution can comprise wastewater from gas and/or oil production from an unconventional subterranean formation (e.g., shale formation). In some examples, the contaminated aqueous solution comprises unconventional oil wastewater (e.g., shale oil wastewater), unconventional gas wastewater (e.g., shale gas wastewater), conventional oil wastewater, conventional gas wastewater, or a combination thereof.

The contaminated aqueous solution can, for example, comprise a particulate contaminant, an inorganic contaminant, an organic contaminant, or a combination thereof. The contaminated aqueous solution can, for example, comprise a carbonaceous contaminant, e.g. the particulate contaminant, the inorganic contaminant, the organic contaminant, or a combination thereof can comprise carbon.

In some examples, the contaminated aqueous solution comprises an inorganic contaminant. Examples of inorganic contaminants include, but are not limited to, chlorides, aluminum, barium, boron, calcium, iron, magnesium, silica, sodium, strontium, sulfates, sulfides, and combinations thereof. In some examples, the contaminated aqueous solution comprises an inorganic contaminant comprising chloride, aluminum, barium, boron, calcium, iron, magnesium, silica, sodium, strontium, sulfate, sulfide, or a combination thereof.

In some examples, the contaminated aqueous solution comprises an organic contaminant. Examples of organic contaminants include, but are not limited to, organic carbon compounds (e.g., benzene, ethylbenzene, toluene, xylenes), surfactants, amphiphilic organic molecules, petroleum hydrocarbons (e.g., recoverable petroleum hydrocarbons, volatile petroleum hydrocarbons, gasoline and diesel range organics, etc.), and combinations thereof. In some examples, the contaminated aqueous solution comprises an organic contaminant comprising organic carbon. In some examples, the contaminated aqueous solution comprises an organic contaminant comprising a surfactant, an amphiphilic organic molecule, or a combination thereof. In some examples, the contaminated aqueous solution comprises an organic contaminant comprising petroleum hydrocarbons (e.g., recoverable petroleum hydrocarbons, volatile petroleum hydrocarbons, gasoline and diesel range organics, etc.). In some examples, the contaminated aqueous solution comprises an organic contaminant comprising recoverable petroleum hydrocarbons, volatile petroleum hydrocarbons, or a combination thereof. In some examples, the contaminated aqueous solution comprises an organic contaminant comprising benzene, ethylbenzene, toluene, xylenes, or a combination thereof.

The contaminated aqueous solution can, for example, have a total dissolved solids content of 0 mg/L or more (e.g., 5 mg/L or more; 10 mg/L or more; 15 mg/L or more; 20 mg/L or more; 25 mg/L or more; 30 mg/L or more; 35 mg/L or more; 40 mg/L or more; 45 mg/L or more; 50 mg/L or more; 60 mg/L or more; 70 mg/L or more; 80 mg/L or more; 90 mg/L or more; 100 mg/L or more; 125 mg/L or more; 150 mg/L or more; 175 mg/L or more; 200 mg/L or more; 225 mg/L or more; 250 mg/L or more; 275 mg/L or more; 300 mg/L or more; 350 mg/L or more; 400 mg/L or more; 450 mg/L or more; 500 mg/L or more; 600 mg/L or more; 700 mg/L or more; 800 mg/L or more; 900 mg/L or more; 1000 mg/L or more; 1250 mg/L or more; 1500 mg/L or more; 1750 mg/L or more; 2000 mg/L or more; 2250 mg/L or more; 2500 mg/L or more; 2750 mg/L or more; 3000 mg/L or more; 3500 mg/L or more; 4000 mg/L or more; 4500 mg/L or more; 5000 mg/L or more; 6000 mg/L or more; 7000 mg/L or more; 8000 mg/L or more; 9000 mg/L or more; 10,000 mg/L or more; 12,500 mg/L or more; 15,000 mg/L or more; 17,500 mg/L or more; 20,000 mg/L or more; 22,500 mg/L or more; 25,000 mg/L or more; 27,500 mg/L or more; 30,000 mg/L or more; 35,000 mg/L or more; 40,000 mg/L or more; 45,000 mg/L or more; 50,000 mg/L or more; 60,000 mg/L or more; 70,000 mg/L or more; 80,000 mg/L or more; 90,000 mg/L or more; 100,000 mg/L or more; 125,000 mg/L or more; 150,000 mg/L or more; 175,000 mg/L or more; 200,000 mg/L or more; 225,000 mg/L or more; 250,000 mg/L or more; 275,000 mg/L or more; 300,000 or more; 325,000 mg/L or more; or 350,000 mg/L or more).

In some examples, the contaminated aqueous solution can have a total dissolved solids content of 400,000 mg/L or less (e.g., 375,000 mg/L or less; 350,000 mg/L or less; 325,000 mg/L or less; 300,000 mg/L or less; 275,000 mg/L or less; 250,000 mg/L or less; 225,000 mg/L or less; 200,000 mg/L or less; 175,000 mg/L or less; 150,000 mg/L or less; 125,000 mg/L or less; 100,000 mg/L or less; 90,000 mg/L or less; 80,000 mg/L or less; 70,000 mg/L or less; 60,000 mg/L or less; 50,000 mg/L or less; 45,000 mg/L or less; 40,000 mg/L or less; 35,000 mg/L or less; 30,000 mg/L or less; 27,500 mg/L or less; 25,000 mg/L or less; 22,500 mg/L or less; 20,000 mg/L or less; 17,500 mg/L or less; 15,000 mg/L or less; 12,500 mg/L or less; 10,000 mg/L or less; 9000 mg/L or less; 8000 mg/L or less; 7000 mg/L or less; 6000 mg/L or less; 5000 mg/L or less; 4500 mg/L or less; 4000 mg/L or less; 3500 mg/L or less; 3000 mg/L or less; 2750 mg/L or less; 2500 mg/L or less; 2250 mg/L or less; 2000 mg/L or less; 1750 mg/L or less; 1500 mg/L or less; 1250 mg/L or less; 1000 mg/L or less; 900 mg/L or less; 800 mg/L or less; 700 mg/L or less; 600 mg/L or less; 500 mg/L or less; 450 mg/L or less; 400 mg/L or less; 350 mg/L or less; 300 mg/L or less; 275 mg/L or less; 250 mg/L or less; 225 mg/L or less; 200 mg/L or less; 175 mg/L or less; 150 mg/L or less; 125 mg/L or less; 100 mg/L or less; 90 mg/L or less; 80 mg/L or less; 70 mg/L or less; 60 mg/L or less; 50 mg/L or less; 45 mg/L or less; 40 mg/L or less; 35 mg/L or less; 30 mg/L or less; 25 mg/L or less; 20 mg/L or less; 15 mg/L or less; 10 mg/L or less; or 5 mg/L or less).

The total dissolved solids content of the contaminated aqueous solution can range from any of the minimum values described above to any of the maximum values described above. For example, the contaminated aqueous solution can have a total dissolved solids content of from 0 mg/L to 400,000 mg/L (e.g., from 0 mg/L to 200,000 mg/L; from 200,000 mg/L to 400,000 mg/L; from 0 mg/L to 100,000 mg/L; from 100,000 mg/L to 200,000 mg/L; from 200,000 mg/L to 300,000 mg/L; from 300,000 mg/L to 400,000 mg/L; from 100 mg/L to 400,000 mg/L; from 0 mg/L to 360,000 mg/L; from 100 mg/L to 360,000 mg/L; from 500 mg/L to 400,000 mg/L; from 1,000 mg/L to 400,000 mg/L; from 5000 mg/L to 400,000 mg/L; from 10,000 mg/L to 40,000 mg/L; from 30,000 mg/L to 400,000 mg/L from 30,000 mg/L to 300,000 mg/L; from 50,000 mg/L to 400,000 mg/L; or from 50,000 mg/L to 300,000 mg/L). The total dissolved solids content can, for example, be determined using EPA Method 160.1; Standard Methods 2540 C; or another appropriate analytical method.

The methods disclosed herein for purifying a contaminated aqueous solution to form a purified aqueous solution (the contaminated aqueous solution comprising a particulate contaminant, an inorganic contaminant, an organic contaminant or a combination thereof) comprise subjecting the contaminated aqueous solution to a first pretreatment comprising coagulation or precipitative softening to form an initial partially purified aqueous solution; subjecting the initial partially purified aqueous solution to a second pretreatment comprising adsorptive filtration to form an intermediate partially purified aqueous solution; and subjecting the intermediate partially purified aqueous solution to membrane distillation to form the purified aqueous solution.

When the first pretreatment comprises coagulation, subjecting the contaminated aqueous solution to the first pretreatment can comprise: contacting the contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separating the supernatant from the coagulated phase; and collecting the supernatant; wherein the supernatant is the initial partially purified aqueous solution.

When the first pretreatment comprises precipitative softening, subjecting the contaminated aqueous solution to the first pretreatment can comprise: contacting the contaminated aqueous solution with an acid or a base (e.g., HCl, NaOH, etc.) to adjust the pH of the contaminated aqueous solution (e.g., to a pH of 10), thereby forming a pH adjusted contaminated aqueous solution; contacting the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separating the supernatant from the coagulated phase; and collecting the supernatant; wherein the supernatant is the initial partially purified aqueous solution.

Contacting the contaminated aqueous solution with the coagulant can, for example, comprise adding the coagulant to the contaminated aqueous solution to form a mixture and agitating the mixture. Agitating the mixture can be accomplished, for example, by mechanical stirring, shaking, vortexing, sonication (e.g., bath sonication, probe sonication, ultrasonication), and the like, or combinations thereof.

Separating the supernatant from the coagulated phase can, for example, comprise decanting, centrifugation, filtration, or a combination thereof.

The coagulant can comprise any suitable coagulant, such as those known in the art. In some examples, the coagulant comprises a ferric salt, an aluminum salt, or a combination thereof. In some examples, the coagulant can comprise ferric chloride, ferric sulfate, aluminum sulfate, aluminum chloride, polyaluminum chloride, aluminum chlorohydrate, or a combination thereof. In some examples, the coagulant comprises ferric chloride, aluminum sulfate octadecahydrate, or a combination thereof. In some examples, the coagulant comprises ferric chloride. In some examples, the coagulant comprises aluminum sulfate octadecahydrate. The coagulant can be provided at any suitable concentration sufficient to provide the desired amount of coagulation. For example, the coagulant can be provided in an amount of from 5 milligrams per liter of the contaminated aqueous solution (mg/L) or more (e.g., 10 mg/L or more, 15 mg/L or more, 20 mg/L or more, 25 mg/L or more, 30 mg/L or more, 35 mg/L or more, 40 mg/L or more, 45 mg/L or more, 50 mg/L or more, 55 mg/L or more, 60 mg/L or more, 65 mg/L or more, 70 mg/L or more, 75 mg/L or more, 80 mg/L or more, 85 mg/L or more, 90 mg/L or more, 95 mg/L or more, 100 mg/L or more, 105 mg/L or more, 110 mg/L or more, 115 mg/L or more, 120 mg/L or more, 125 mg/L or more, 130 mg/L or more, 135 mg/L or more, or 140 mg/L or more). In some example, the coagulant can be provided in an amount of 150 mg/L or less (e.g., 145 mg/L or less, 140 mg/L or less, 135 mg/L or less, 130 mg/L or less, 125 mg/L or less, 120 mg/L or less, 115 mg/L or less, 110 mg/L or less, 105 mg/L or less, 100 mg/L or less, 95 mg/L or less, 90 mg/L or less, 85 mg/L or less, 80 mg/L or less, 75 mg/L or less, 70 mg/L or less, 65 mg/L or less, 60 mg/L or less, 55 mg/L or less, 50 mg/L or less, 45 mg/L or less, 40 mg/L or less, 35 mg/L or less, 30 mg/L or less, 25 mg/L or less, 20 mg/L or less, 15 mg/L or less, or 10 mg/L or less). The amount of coagulant can range from any of the minimum values described above to any of the maximum valued described above. For example, the coagulant can be provided in an amount of from 5 mg/L to 150 mg/L (e.g., from 5 mg/L to 75 mg/L, from 75 mg/L to 150 mg/L, from 5 mg/L to 50 mg/L, from 50 mg/L to 100 mg/L, from 100 mg/L to 150 mg/L, from 5 mg/L to 140 mg/L, from 10 mg/L to 150 mg/L, from 10 mg/L to 140 mg/L, from 5 mg/L to 100 mg/L, from 5 mg/L to 40 mg/L, or from 10 mg/L to 30 mg/L). In some examples, the coagulant comprises ferric chloride and the coagulant is provided in an amount of 25 mg/L. In some examples, the coagulant comprises aluminum sulfate octadecahydrate and the coagulant is provided in an amount of 15 mg/L. The amount of coagulant can be selected in view of a variety of factors, such as the identity of the coagulant, the level and nature of contaminants in the contaminated aqueous solution, the desired level of coagulation, or a combination thereof.

The first pretreatment can, for example, remove at least first portion of the particulate contaminant, at least a first portion of the organic contaminant, at least a first portion of the inorganic contaminant, or a combination thereof to reduce fouling and scaling potential of the initial partially purified aqueous solution in the subsequent method steps.

In some examples, the contaminated aqueous solution has a turbidity and the first pretreatment can reduce the turbidity by 90% or more (e.g., 91% or more, 92% or more, 93% or more, 94% or more, 95% or more, 96% or more, 97% or more, 98% or more, or 99% or more). In some examples, the contaminated aqueous solution has a turbidity, the initial purified aqueous solution has a turbidity, and the turbidity of the initial purified aqueous solution is lower than the turbidity of the contaminated aqueous solution by 90% or more (e.g., 91% or more, 92% or more, 93% or more, 94% or more, 95% or more, 96% or more, 97% or more, 98% or more, or 99% or more). In some examples, the contaminated aqueous solution comprises a particulate contaminant and the first portion of the particulate contaminant removed by the first pretreatment is 90% or more of the particulate contaminant (e.g., 91% or more, 92% or more, 93% or more, 94% or more, 95% or more, 96% or more, 97% or more, 98% or more, or 99% or more).

In some examples, the contaminated aqueous solution has an alkalinity and the first pretreatment can reduce the alkalinity by 5% or more (e.g., 10% or more, 15% or more, 20% or more, 25% or more, 30% or more, 35% or more, 40% or more, 45% or more, 50% or more, 55% or more, 60% or more, 75% or more, or 90% or more). In some examples, the contaminated aqueous solution has an alkalinity, the initial purified aqueous solution has an alkalinity, and the alkalinity of the initial purified aqueous solution is lower than the alkalinity of the contaminated aqueous solution by 5% or more (e.g., 10% or more, 15% or more, 20% or more, 25% or more, 30% or more, 35% or more, 40% or more, 45% or more, 50% or more, 55% or more, 60% or more, 75% or more, or 90% or more).

In some examples, the contaminated aqueous solution comprises an inorganic contaminant comprising aluminum and the first portion of the inorganic contaminant removed by the first pretreatment comprises 40% or more of the aluminum (e.g., 45% or more, 50% or more, 55% or more, 60% or more, 75% or more, or 90% or more). In some examples, the contaminated aqueous solution comprises an inorganic contaminant comprising barium and the first portion of the inorganic contaminant removed by the first pretreatment comprises 40% or more of the barium (e.g., 45% or more, 50% or more, 55% or more, 60% or more, 75% or more, or 90% or more). In some examples, the contaminated aqueous solution comprises an inorganic contaminant comprising calcium and the first portion of the inorganic contaminant removed by the first pretreatment comprises 40% or more of the calcium (e.g., 45% or more, 50% or more, 55% or more, 60% or more, 75% or more, or 90% or more). In some examples, the contaminated aqueous solution comprises an inorganic contaminant comprising aluminum, barium, calcium, or a combination thereof and the first portion of the inorganic contaminant removed by the first pretreatment comprises 40% or more of the aluminum, barium, calcium, or a combination thereof (e.g., 45% or more, 50% or more, 55% or more, 60% or more, 75% or more, or 90% or more).

In some examples, the contaminated aqueous solution comprises an inorganic contaminant comprising magnesium and the first portion of the inorganic contaminant removed by the first pretreatment comprises 15% or more of the magnesium (e.g., 20% or more, 25% or more, 30% or more, 35% or more, 40% or more, 50% or more, 75% or more, or 90% or more). In some examples, the contaminated aqueous solution comprises an inorganic contaminant comprising chloride and the first portion of the inorganic contaminant removed by the first pretreatment comprises 5% or more of the chloride (e.g., 10% or more, 15% or more, 20% or more, 25% or more, 50% or more, 75% or more, or 90% or more). In some examples, the contaminated aqueous solution comprises an inorganic contaminant comprising silica and the first portion of the inorganic contaminant removed by the first pretreatment comprises 30% or more of the silica (e.g., 35% or more, 40% or more, 45% or more, 50% or more, 75% or more, or 90% or more). In some examples, the contaminated aqueous solution comprises an inorganic contaminant comprising strontium and the first portion of the inorganic contaminant removed by the first pretreatment comprises 15% or more of the strontium (e.g., 20% or more, 25% or more, 30% or more, 35% or more, 40% or more, 50% or more, 75% or more, or 90% or more).

In some examples, the contaminated aqueous solution has a total dissolved solids content and the first pretreatment reduces the total dissolved solids content by 5% or more (e.g., 10% or more, 15% or more, 20% or more, 25% or more, 50% or more, 75% or more, or 90% or more).

In some examples, the contaminated aqueous solution comprises an organic contaminant comprising organic carbons, such that the contaminated aqueous solution has a total organic carbon content, and the first portion of the organic contaminant removed by the first pretreatment is 30% or more of the total organic carbon (e.g., 35% or more, 40% or more, 45% or more, 50% or more, 55% or more, 60% or more, 75% or more, or 90% or more). In some examples, the contaminated aqueous solution comprises an organic contaminant comprising recoverable petroleum hydrocarbons, such that the contaminated aqueous solution has a total recoverable petroleum hydrocarbon content and the first portion of the organic contaminant removed by the first pretreatment is 30% or more of the total recoverable petroleum hydrocarbons (e.g., 35% or more, 40% or more, 45% or more, 50% or more, 55% or more, 60% or more, 75% or more, or 90% or more). In some examples, the contaminated aqueous solution comprises an organic contaminant comprising ethyl benzene, such that the contaminated aqueous solution has an ethyl benzene content, and the first portion of the organic contaminant removed by the first pretreatment is 30% or more of the ethyl benzene (e.g., 35% or more, 40% or more, 45% or more, 50% or more, 55% or more, 60% or more, 75% or more, or 90% or more). In some examples, the contaminated aqueous solution comprises an organic contaminant comprising a xylene, such that the contaminated aqueous solution has a total xylene content, and the first portion of the organic contaminant removed by the first pretreatment is 30% or more of the total xylenes (e.g., 35% or more, 40% or more, 45% or more, 50% or more, 55% or more, 60% or more, 75% or more, or 90% or more). In some examples, the contaminated aqueous solution comprises an organic contaminant such that the contaminated aqueous solution has a total organic carbon content, a total recoverable petroleum hydrocarbon content, an ethyl benzene content, a total xylene content, or a combination thereof; and the first portion of the organic contaminant removed by the first pretreatment is 30% or more of the total organic carbon content, the total recoverable petroleum hydrocarbon content, the ethyl benzene content, the total xylene content, or a combination thereof (e.g., 35% or more, 40% or more, 45% or more, 50% or more, 55% or more, 60% or more, 75% or more, or 90% or more).

The methods further comprise subjecting the initial partially purified aqueous solution to a second pretreatment comprising adsorptive filtration to form an intermediate partially purified aqueous solution. Subjecting the initial partially purified aqueous solution to the second pretreatment can, for example, comprise: introducing the initial partially purified aqueous solution as an influent to a filter column packed with an adsorbent filter media such that the initial partially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and collecting an effluent from the filter column, wherein the effluent is the intermediate partially purified aqueous solution. and

The adsorbent filter media can comprise any suitable media, such as those known in the art. In some examples, the adsorbent filter media comprises a plurality of particles comprising activated carbon, a nut shell (e.g., walnut, pecan, coconut, etc.), or a combination thereof. In some examples, the adsorbent filter media comprises a plurality of particles comprising a coconut shell, a walnut shell, a pecan shell, or a combination thereof. In some examples, the adsorbent filter media comprises a plurality of particles comprising walnut shells.

The plurality of particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.). For an anisotropic particle, the average particle size can refer to, for example, the hydrodynamic size of the particle. Mean particle size can be measured using methods known in the art. As used herein, the average particle size is determined by a sieve analysis or gradation test.

In some examples, the adsorbent filter media comprises a plurality of particles having an average particle size of 50 micrometers (μm, microns) or more (e.g., 60 μm or more, 70 μm or more, 80 μm or more, 90 μm or more, 100 μm or more, 125 μm or more, 150 μm or more, 175 μm or more, 200 μm or more, 225 μm or more, 250 μm or more, 275 μm or more, 300 μm or more, 325 μm or more, 350 μm or more, 375 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, 950 μm or more, 1000 μm or more, 1100 μm or more, 1200 μm or more, 1300 μm or more, 1400 μm or more, 1500 μm or more, 1600 μm or more, 1700 μm or more, 1800 μm or more, 1900 μm or more, 2000 μm or more, 2250 μm or more, 2500 μm or more, or 2750 μm or more). In some examples, the adsorbent filter media comprises a plurality of particles having an average particle size of 3000 μm or less (e.g., 2750 μm or less, 2500 μm or less, 2250 μm or less, 2000 μm or less, 1900 μm or less, 1800 μm or less, 1700 μm or less, 1600 μm or less, 1500 μm or less, 1400 μm or less, 1300 μm or less, 1200 μm or less, 1100 μm or less, 1000 μm or less, 950 μm or less, 900 μm or less, 850 μm or less, 800 μm or less, 750 μm or less, 700 μm or less, 650 μm or less, 600 μm or less, 550 μm or less, 500 μm or less, 450 μm or less, 400 μm or less, 375 μm or less, 350 μm or less, 325 μm or less, 300 μm or less, 275 μm or less, 225 μm or less, 200 μm or less, 175 μm or less, 150 μm or less, 125 μm or less, 100 μm or less, 90 μm or less, 80 μm or less, 70 μm or less, or 60 μm or less). The average particle size of the plurality of particles comprising the adsorbent filter media can range from any of the minimum values described above to any of the maximum values described above. For example, the adsorbent filter media comprises a plurality of particles having an average particle size of from 50 μm to 3000 μm (e.g., from 50 μm to 1500 μm, from 1500 μm to 3000 μm, from 50 μm to 1000 μm from 1000 μm to 2000 μm, from 2000 μm to 3000 μm, from 50 μm to 2500 μm, from 100 μm to 4000 μm, from 100 μm to 4000 μm, or from 400 μm to 1600 μm).

In some examples, the plurality of particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the average particle size, within 15% of the average particle size, within 10% of the average particle size, or within 5% of the average particle size).

The plurality of particles can comprise particles of any shape (e.g., a sphere, a rod, a quadrilateral, an ellipse, a triangle, a polygon, etc.). In some examples, the plurality of particles can have a regular shape, an irregular shape, an isotropic shape, an anisotropic shape, or a combination thereof. In some examples, the plurality of particles are each substantially spherical in shape.

In some examples, the plurality of particles can comprise: a first population of particles having a first average particle size, a first particle shape, and a first composition; and a second population of particles having a second average particle size, a second particle shape, and a second composition; wherein the first average particle size and the second average particle size are different, the first particle shape and the second particle shape are different, the first composition and the second composition are different, or a combination thereof. In some examples, the plurality of particles can comprise a mixture of a plurality of populations of particles, wherein each population of particles within the mixture is different with respect to average particle size, particle shape, composition, or a combination thereof.

In some examples, the flow of the initially purified aqueous solution through the filter column can be gravity assisted. In some examples, the flow of the initially purified aqueous solution through the filter column can be due to an applied external pressure (e.g., pressure filtration, vacuum filtration). The initially partially purified aqueous solution can flow through the filter column at a flow rate; the flow rate can, for example, be selected based on the size of the column.

The packing density of the filter column; the dimensions of the filter column; the number of filter columns; the size, shape, and/or composition of the adsorbent filter media; the flow rate of the initially purified aqueous solution through the filter column; or a combination thereof can be selected in view of a variety of factors, such as the identity and/or concentration of the particulate contaminant, the inorganic contaminant, the organic contaminant, or a combination thereof; the desired amount of the particulate contaminant, the inorganic contaminant, the organic contaminant, or a combination thereof removed by the second pretreatment; or a combination thereof.

The second pretreatment can, for example, remove at least second portion of the particulate contaminant, at least a second portion of the organic contaminant, at least a second portion of the inorganic contaminant, or a combination thereof to reduce fouling and scaling potential of the intermediate partially purified aqueous solution in the subsequent method steps. In some examples, second pretreatment can, for example, remove at least a portion of volatile organic compounds (e.g., BTEX), along with gasoline and diesel range organic compounds.

In some examples, the initial partially purified aqueous solution comprises an organic contaminant comprising benzene, ethylbenzene, toluene, and xylenes, such that the initial partially purified aqueous solution has a total BTEX concentration; wherein the total BTEX concentration is the total concentration of benzene, ethylbenzene, toluene, and xylenes; and the second pretreatment reduces the total BTEX concentration by 90% or more (e.g., 91% or more, 92% or more, 93% or more, 94% or more, 95% or more, 96% or more, 97% or more, 98% or more, or 99% or more). In some examples, the initial partially purified aqueous solution comprises an organic contaminant comprising benzene, ethylbenzene, toluene, and xylenes, such that the initial partially purified aqueous solution has a total BTEX concentration; wherein the total BTEX concentration is the total concentration of benzene, ethylbenzene, toluene, and xylenes; and wherein the second portion of the organic contaminant removed by the second pretreatment comprises 90% or more of the total BTEX concentration (e.g., 91% or more, 92% or more, 93% or more, 94% or more, 95% or more, 96% or more, 97% or more, 98% or more, or 99% or more).

In some examples, the initial partially purified aqueous solution comprises an inorganic contaminant comprising boron, and the second portion of the inorganic contaminant removed by the second pretreatment comprises 60% or more of the boron (e.g., 65% or more, 70% or more, 75% or more, 80% or more, 85% or more, 90% or more, or 95% or more).

In some examples, the initial partially purified aqueous solution comprises an organic contaminant comprising volatile petroleum hydrocarbons, such that the initial partially purified aqueous solution has a total volatile petroleum hydrocarbon concentration, and the second pretreatment removes 90% or more of the total volatile petroleum hydrocarbons (e.g., 91% or more, 92% or more, 93% or more, 94% or more, 95% or more, 96% or more, 97% or more, 98% or more, or 99% or more). In some examples, the initial partially purified aqueous solution comprises an organic contaminant comprising volatile petroleum hydrocarbons, such that the initial partially purified aqueous solution has a total volatile petroleum hydrocarbon concentration, and the second portion of the organic contaminant removed by the second pretreatment comprises 90% or more of the total volatile petroleum hydrocarbon concentration (e.g., 91% or more, 92% or more, 93% or more, 94% or more, 95% or more, 96% or more, 97% or more, 98% or more, or 99% or more).

In some examples, the initial partially purified aqueous solution comprises an organic contaminant comprising recoverable petroleum hydrocarbons, such that the initial partially purified aqueous solution has a total recoverable petroleum hydrocarbon concentration, and the second pretreatment removed 70% or more or the total recoverable petroleum hydrocarbons (e.g., 75% or more, 80% or more, 85% or more, 90% or more, or 95% or more). In some examples, the initial partially purified aqueous solution comprises an organic contaminant comprising recoverable petroleum hydrocarbons, such that the initial partially purified aqueous solution has a total recoverable petroleum hydrocarbon concentration, and the second portion of the organic contaminant removed by the second pretreatment comprises 70% or more of the total recoverable petroleum hydrocarbon concentration (e.g., 75% or more, 80% or more, 85% or more, 90% or more, or 95% or more).

In some examples, the initial partially purified aqueous solution has an alkalinity and the second pretreatment reduces the alkalinity by 5% or more (e.g., 10% or more, 15% or more, 20% or more, 25% or more, 30% or more, 35% or more, 40% or more, 45% or more, 50% or more, 55% or more, 60% or more, 75% or more, or 90% or more). In some examples, the initial purified aqueous solution comprises an inorganic contaminant comprising barium and the second pretreatment removes 30% or more of the barium (e.g., 35% or more, 40% or more, 45% or more, 50% or more, 75% or more, or 90% or more). In some examples, the initial purified aqueous solution comprises an inorganic contaminant comprising chloride and the second pretreatment removes 20% or more of the chloride (e.g., 25% or more, 30% or more, 35% or more, 40% or more, 45% or more, 50% or more, 75% or more, or 90% or more). In some examples, the initial partially purified aqueous solution comprises an inorganic contaminant comprising silica and the second pretreatment removes 30% or more of the silica (e.g., 35% or more, 40% or more, 45% or more, 50% or more, 75% or more, or 90% or more). In some examples, the initial partially purified aqueous solution comprises an inorganic contaminant comprising strontium and the second pretreatment removes 25% or more of the strontium (e.g., 30% or more, 35% or more, 40% or more, 45% or more, 50% or more, 75% or more, or 90% or more).

The methods further comprise subjecting the intermediate partially purified aqueous solution to membrane distillation to form the purified aqueous solution. Subjecting the intermediate partially purified aqueous solution to membrane distillation can, for example, comprise: distilling the intermediate partially purified aqueous solution through a porous distillation membrane thereby producing a distillate; and collecting the distillate; wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and wherein the distillate is the purified aqueous solution.

The porous distillation membrane can comprise any membrane suitable for membrane distillation, such as those known in the art. In some examples, the porous distillation membrane can comprise a polymer, such as a hydrophobic polymer. Examples of suitable polymers include, but are not limited to, polyolefins (e.g., polypropylene, polyethylene, polyisobutylene, polymethylpentene, polybutylene, ethylene propylene rubber, and ethylene propylene diene monomer rubber), polycarbonates, polyesters (e.g., polyglycolic acid, polylactic acid, polycaprolactone, polyhydroxyalkanoates, polyethylene terephthalate (PET), polybutylene terephthalate, polytrimethylene terephthalate, and polyethylene naphthalate), polyurethanes, polyamides (e.g., Nylon), polystyrene, polyacrylates, ABS (acrylonitrile butadiene styrene copolymers), vinyl polymers (e.g., polyvinyl chloride), fluoropolymers (e.g., polytetrafluoroethylene, polyvinylidene fluoride), copolymers thereof, and blends thereof. In some examples, the polymer can comprise polytetrafluoroethylene, polyvinylidene chloride, polyvinylidene fluoride, polyethylene, polypropylene, polymethylmethacrylate, polystyrene, polyester, polyethylene terephthalate; derivatives thereof, copolymers thereof, blends thereof, or combinations thereof. In some examples, the porous distillation membrane can comprise polyvinylidene fluoride (PVDF).

The porous distillation membrane can, for example, be permeated by a plurality of pores. The plurality of pores can have an average pore size. As used herein “pore size” refers to the largest cross-sectional dimension of a pore in a plane perpendicular to the longitudinal axis of the pore. For example, in the case of a substantially cylindrical pore, the pore size would be the diameter of the pore. The average pore size can be determined, for example, using electron microscopy (e.g., scanning electron microscopy (SEM), scanning transmission electron microscopy (STEM)), Brunauer-Emmett-Teller (BET) measurements, porosimetry, or a combination thereof.

The plurality of pores can, for example, have an average pore size of 0.1 μm or more (e.g., 0.15 μm or more, 0.2 μm or more, 0.25 μm or more, 0.3 μm or more, 0.35 μm or more, 0.4 μm or more, 0.45 μm or more, 0.5 μm or more, 0.55 μm or more, 0.6 μm or more, 0.65 μm or more, 0.7 μm or more, 0.75 μm or more, 0.8 μm or more, 0.85 μm or more, or 0.9 μm or more). In some examples, the plurality of pores can have an average pore size of 1 μm or less (e.g., 0.95 μm or less, 0.9 μm or less, 0.85 μm or less, 0.8 μm or less, 0.75 μm or less, 0.7 μm or less, 0.65 μm or less, 0.6 μm or less, 0.55 μm or less, 0.5 μm or less, 0.45 μm or less, 0.4 μm or less, 0.35 μm or less, 0.3 μm or less, 0.25 μm or less, or 0.2 μm or less). The average pore size of the plurality of pores can range from any of the minimum values described above to any of the maximum values described above. For example, the plurality of pores can have an average pore size of from 0.1 μm to 1 μm (e.g., from 0.1 μm to 0.5 μm, from 0.5 μm to 1 μm, from 0.1 μm to 0.3 μm, from 0.3 μm to 0.6 μm, from 0.6 μm to 1 μm, from 0.1 μm to 0.9 μm, from 0.2 μm to 1 μm, from 0.2 μm to 0.9 μm, or from 0.4 μm to 0.5 μm).

The porous distillation membrane can, for example, have an average thickness of 25 μm or more (e.g., 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, 95 μm or more, 100 μm or more, 105 μm or more, 110 μm or more, 115 μm or more, 120 μm or more, 125 μm or more, 130 μm or more, 135 μm or more, 140 μm or more, 145 μm or more, 150 μm or more, 155 μm or more, 160 μm or more, 165 μm or more, 170 μm or more, 175 μm or more, 180 μm or more, 185 μm or more, or 190 μm or more). In some examples, the porous distillation membrane can have an average thickness of 200 μm or less (e.g., 195 μm or less, 190 μm or less, 185 μm or less, 180 μm or less, 175 μm or less, 170 μm or less, 165 μm or less, 160 μm or less, 155 μm or less, 150 μm or less, 145 μm or less, 140 μm or less, 135 μm or less, 130 μm or less, 125 μm or less, 120 μm or less, 115 μm or less, 110 μm or less, 105 μm or less, 100 μm or less, 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, or 30 μm or less). The average thickness of the porous distillation membrane can range from any of the minimum values described above to any of the maximum values described above. For example, the porous distillation membrane can have an average thickness of from 25 μm to 200 μm (e.g., from 25 μm to 100 μm, from 100 μm to 200 μm, from 25 μm to 60 μm, from 60 μm to 95 μm, from 95 μm to 130 μm, from 130 μm to 165 μm, from 165 μm to 200 μm, from 25 μm to 175 μm, from 50 μm to 200 μm, from 50 μm to 175 μm, from 75 μm to 150 μm, from 80 μm to 140 μm, from 100 μm to 150 μm, or from 120 μm to 130 μm).

In some examples, distilling the intermediate partially purified aqueous solution through a porous distillation membrane can comprise heating the intermediate partially purified aqueous solution to dill the intermediate partially purified aqueous solution through the porous distillation membrane. In certain examples, the heat can be provided by geothermal energy, a natural gas boiler, or the like.

In some examples, the vapor flux (e.g., water flux) across the porous distillation membrane decreases by 20% or less over the course of the membrane distillation (e.g., 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less).

In some examples, the porous distillation membrane exhibits a normalized vapor flux (e.g., a normalized vapor flux) of 0.8 or more over the course of the membrane distillation (e.g., 0.85 or more, 0.9 or more, 0.95 or more, 1 or more, 1.05 or more, 1.1 or more, or 1.15 or more). In some examples, the porous distillation membrane exhibits a normalized vapor flux (e.g., a normalized vapor flux) of 1.2 or less over the course of the membrane distillation (e.g., 1.15 or less, 1.1 or less, 1.05 or less, 1 or less, 0.95 or less, 0.9 or less, or 0.85 or less). The normalized vapor flux (e.g., normalized water flux) can range from any of the minimum values described above to any of the maximum values described above. For example, the porous distillation membrane exhibits a normalized vapor flux (e.g., a normalized vapor flux) of from 0.8 to 1.2 over the course of the membrane distillation (e.g., from 0.8 to 1, from 1 to 1.2, from 0.8 to 0.9, from 0.9 to 1, from 1 to 1.1, from 1.1 to 1.2, from 0.8 to 1.1, from 0.9 to 1.2, or from 0.9 to 1.1).

In some examples, the distillate has a conductivity of 100 μS/cm or less over the course of the distillation (e.g., 95 μS/cm or less, 90 μS/cm or less, 85 μS/cm or less, 80 μS/cm or less, 75 μS/cm or less, 70 μS/cm or less, 65 μS/cm or less, 60 μS/cm or less, 55 μS/cm or less, 50 μS/cm or less, 45 μS/cm or less, 40 μS/cm or less, 35 μS/cm or less, 30 μS/cm or less, 25 μS/cm or less, 20 μS/cm or less, 15 μS/cm or less, 10 μS/cm or less, or 5 μS/cm or less).

In some examples, the porous distillation membrane exhibits a salt rejection of 90% or more over the course of the membrane distillation (e.g., 91% or more, 92% or more, 93% or more, 94% or more, 95% or more, 96% or more, 97% or more, 98% or more, or 99% or more).

In some examples, the porous distillation membrane exhibits a salt rejection of 99% or more over the course of the membrane distillation (e.g., 99.1% or more, 99.2% or more, 99.3% or more, 99.4% or more, 99.5% or more, 99.6% or more, 99.7% or more, 99.8% or more, or 99.9% or more).

In some examples, the distillate is collected in an amount that corresponds to a total water recovery of 80% or more over the course of the membrane distillation (e.g., 81% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more, or 99% or more).

In some examples, the course of the membrane distillation comprises when the distillate is collected in an amount that corresponds to a total water recovery of 80% or more (e.g., 81% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more, or 99% or more).

In some examples, the contaminated aqueous solution comprises an inorganic contaminant comprising boron, such that the contaminated aqueous solution has a boron content, and the combination of the first pretreatment, the second pretreatment, and the membrane distillation removes 99% or more of the boron (e.g., 99.1% or more, 99.2% or more, 99.3% or more, 99.4% or more, 99.5% or more, 99.6% or more, 99.7% or more, 99.8% or more, or 99.9% or more). In some examples, the contaminated aqueous solution comprises an inorganic contaminant comprising boron, such that the contaminated aqueous solution has a boron content, and the sum of the first portion of the inorganic contaminant removed by the first pretreatment, the second portion of the inorganic contaminant removed by the second pretreatment, and the third portion of the inorganic contaminant removed by the membrane distillation comprises 99% or more of the boron content (e.g., 99.1% or more, 99.2% or more, 99.3% or more, 99.4% or more, 99.5% or more, 99.6% or more, 99.7% or more, 99.8% or more, or 99.9% or more).

In some examples, the contaminated aqueous solution comprises an organic contaminant comprising benzene, ethylbenzene, toluene, and xylenes, such that the contaminated aqueous solution has a total BTEX concentration; wherein the total BTEX concentration is the total concentration of benzene, ethylbenzene, toluene, and xylenes; and the combination of the first pretreatment, the second pretreatment, and the membrane distillation removes 95% or more of the total BTEX concentration (e.g., 96% or more, 97% or more, 98% or more, or 99% or more). In some examples, the contaminated aqueous solution comprises an organic contaminant comprising benzene, ethylbenzene, toluene, and xylenes, such that the contaminated aqueous solution has a total BTEX concentration; wherein the total BTEX concentration is the total concentration of benzene, ethylbenzene, toluene, and xylenes; and wherein the sum of the first portion of the organic contaminant removed by the first pretreatment, the second portion of the organic contaminant removed by the second pretreatment, and the third portion of the organic contaminant removed by the membrane distillation comprises 95% or more of the total BTEX concentration (e.g., 96% or more, 97% or more, 98% or more, or 99% or more).

In some examples, the purified aqueous solution has a boron concentration of 0.5 mg/L or less (e.g., 0.4 mg/L or less, 0.3 mg/L or less, 0.2 mg/L or less, 0.1 mg/L or less, 0.09 mg/L or less, 0.08 mg/L or less, 0.07 mg/L or less, 0.06 mg/L or less, 0.05 mg/L or less, 0.04 mg/L or less, 0.03 mg/L or less, 0.02 mg/L or less, 0.01 mg/L or less, 0.009 mg/L or less, 0.008 mg/L or less, 0.007 mg/L or less, 0.006 mg/L or less, 0.005 mg/L or less, 0.004 mg/L or less, 0.003 mg/L or less, 0.002 mg/L or less, or 0.001 mg/L or less). In some examples, the purified aqueous solution has a boron concentration of 0.05 mg/L or less. In some examples, the purified aqueous solution has a total BTEX concentration of 100 μg/L or less (e.g., 90 μg/L or less, 80 μg/L or less, 70 μg/L or less, 60 μg/L or less, 50 μg/L or less, 45 μg/L or less, 40 μg/L or less, 35 μg/L or less, 30 μg/L or less, 25 μg/L or less, 20 μg/L or less, 15 μg/L or less, 10 μg/L or less, 5 μg/L or less, or 1 μg/L or less). In some examples, the purified aqueous solution has a total recoverable petroleum hydrocarbon concentration of 5 mg/L or less (e.g., 4.5 mg/L or less, 4 mg/L or less, 3.5 mg/L or less, 3 mg/L or less, 2.5 mg/L or less, 2 mg/L or less, 1.5 mg/L or less, 1 mg/L or less, 0.5 mg/L or less, 0.1 mg/L or less, 0.05 mg/L or less, or 0.01 mg/L or less). In some examples, the purified aqueous solution has a total volatile petroleum hydrocarbon concentration of 1 mg/L or less (e.g., 0.9 mg/L or less, 0.8 mg/L or less, 0.7 mg/L or less, 0.6 mg/L or less, 0.5 mg/L or less, 0.4 mg/L or less, 0.3 mg/L or less, 0.2 mg/L or less, 0.1 mg/L or less, 0.075 mg/L or less, 0.05 mg/L or less, 0.025 mg/L or less, or 0.01 mg/L or less). In some examples, the purified aqueous solution has a boron concentration of 0.5 mg/L or less; a total BTEX concentration of 100 μg/L or less; a total recoverable petroleum hydrocarbon concentration of 5 mg/L or less; a total volatile petroleum hydrocarbon concentration of 1 mg/L or less; or a combination thereof.

In some examples, the purified aqueous solution meets the typical National Pollutant Discharge Elimination System discharge limit with respect to one or more contaminants. In some examples, the purified aqueous solution meets the typical National Pollutant Discharge Elimination System discharge limit with respect to boron content, total BTEX concentration, or a combination thereof.

In some examples, the purified aqueous solution meets regulatory requirements for irrigation and typical discharge limits. In some examples, the boron content, the total BTEX concentration, or a combination thereof in the purified aqueous solution meet regulatory requirements for irrigation and typical discharge limits.

In some examples, the methods can further comprise purifying a second contaminated aqueous solution to form a second purified aqueous solution. In some examples, the methods can further comprise cleaning the porous distillation membrane before purifying the second contaminated aqueous solution and using the cleaned porous distillation membrane to form the second purified aqueous solution. In some examples, the methods can further comprise purifying multiple contaminated aqueous solutions. In some examples, the methods can further comprise cleaning the porous distillation membrane at regular intervals. Cleaning the porous distillation membrane can, for example, comprise physically cleaning and/or rinsing the porous distillation membrane.

In some examples, the combination of the first pretreatment and the second pretreatment before the membrane distillation can reduce the fouling and scaling potential, thereby leading to more stable membrane distillation performance, improved membrane reusability, and improved quality of produced water distillate.

Also disclosed herein are systems for performing any of the methods described herein. For example, also disclosed herein are systems for purifying a contaminated aqueous solution to form a purified aqueous solution; the contaminated aqueous solution comprising a particulate contaminant, an inorganic contaminant, an organic contaminant or a combination thereof; and the system comprising: a first pretreatment component configured to receive a contaminated aqueous solution and subject the contaminated aqueous solution to a first pretreatment comprising coagulation or precipitative softening to form an initial partially purified aqueous solution; a second pretreatment component fluidly connected to the first pretreatment component, wherein the second pretreatment component is configured to receive the initial partially purified aqueous solution from the first pretreatment component and subject the initial partially purified aqueous solution to a second pretreatment comprising adsorptive filtration to form an intermediate partially purified aqueous solution; and a membrane distillation component fluidly connected to the second pretreatment component, wherein the membrane distillation component is configured to receive the intermediate partially purified aqueous solution from the second pretreatment component and subject the intermediate partially purified aqueous solution to membrane distillation to form the purified aqueous solution.

When the first pretreatment comprises coagulation, the first pretreatment component is configured to: contact the contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separate the supernatant from the coagulated phase; and collect the supernatant; wherein the supernatant is the initial partially purified aqueous solution.

When the first pretreatment comprises precipitative softening, the first pretreatment component is configured to: contact the contaminated aqueous solution with an acid or a base to adjust the pH of the contaminated aqueous solution, thereby forming a pH adjusted contaminated aqueous solution; contact the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant; separate the supernatant from the coagulated phase; and collect the supernatant; wherein the supernatant is the initial partially purified aqueous solution.

The second pretreatment component is configured to: introduce the initial partially purified aqueous solution as an influent to a filter column packed with an adsorbent filter media such that the initially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and collect an effluent from the filter column, wherein the effluent is the intermediate partially purified aqueous solution.

The membrane distillation component is configured to: distill the intermediate partially purified aqueous solution through a porous distillation membrane thereby producing a distillate; and collect the distillate; wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and wherein the distillate is the purified aqueous solution.

In some examples, the system is configured as an onsite and/or mobile wastewater treatment package.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Effective Treatment of Shale Oil and Gas Produced Water by Membrane Distillation Coupled with Precipitative Softening and Walnut Shell Filtration

Abstract. An integrated treatment train was developed that enables effective treatment of shale oil and gas produced water generated from the Wattenberg field in northeast Colorado. Membrane distillation (MD) was performed in tandem with simple and inexpensive pretreatment steps, namely precipitative softening (PS) and walnut shell filtration (WSF). Precipitative softening removed various particulate, organic, and inorganic foulants, thereby mitigating fouling and scaling potential of the produced water. Walnut shell filtration displayed exceptional efficiencies (≥95%) in eliminating volatile toxic compounds including benzene, ethylbenzene, toluene, and xylenes (BTEX) along with additional gasoline and diesel range organic compounds. With pretreatment, the water vapor flux of membrane distillation decreased by only 10% at a total water recovery of 82.5%, with boron and total BTEX concentrations in the membrane distillation distillate meeting the regulatory requirements for irrigation and typical discharge limits, respectively. The use of pretreatment also led to robust membrane reusability within three consecutive treatment cycles, with membrane distillation water flux fully restored after physical membrane cleaning. These results highlight the importance of pretreatment prior to membrane distillation treatment of produced water and demonstrate the potential of the treatment train to achieve a cost-effective and on-site wastewater treatment system that improves the sustainability of the shale oil and gas industry.

Introduction. The application of horizontal drilling and high-volume hydraulic fracturing techniques has expanded the extraction of hydrocarbon resources from unconventional oil and gas reservoirs in the U.S. (Shaffer D L et al. Environ. Sci. Technol. 2013, 47, 9569-9583; Vidic R D et al. Science 2013, 340, 1235009; Gregory K B et al. Elements 2011, 7, 181-186). The boom of the shale oil and gas industry has not only enhanced the energy security of the U.S., but has also disrupted the oil and gas markets by driving down prices worldwide. However, shale oil and gas production consumes large amounts of fresh water and produces a substantial volume of hazardous wastewater (Gregory K B et al. Elements 2011, 7, 181-186; Kondash A et al. Environ. Sci. Technol. Lett. 2015, 2, 276-280), creating a dual challenge of water scarcity and pollution at the water-energy nexus. Current wastewater management options, including deep-well injection and direct discharge into surface water or publicly owned treatment works (POTWs), are either impractical or limited due to the adverse impacts on natural water resources, expensive disposal costs, as well as geological and legal restrictions (Shaffer D L et al. Environ. Sci. Technol. 2013, 47, 9569-9583; Vidic R D et al. Science 2013, 340, 1235009; Gregory K B et al. Elements 2011, 7, 181-186). Effective and economically feasible wastewater treatment technologies, therefore, are highly desirable to improve the sustainability and viability of the shale oil and gas industry.

Shale oil and gas wastewater is challenging to treat due to its complex physicochemical properties. This unique type of wastewater contains high contents of total dissolved solids (TDS) and organic pollutants, which are derived from the dissolution of minerals and organic constituents of the shale formation (Gregory K B et al. Elements 2011, 7, 181-186; Shih J S et al. Environ. Sci. Technol. 2015, 49, 9557-9565). For example, the total dissolved solids of produced water from the Marcellus shale play ranged up to 390,000 mg/L with a median value of 88,000 mg/L (Shih J S et al. Environ. Sci. Technol. 2015, 49, 9557-9565). Such a high salinity exceeds the typical desalination limit (e.g., total dissolved solids of 70,000 mg/L) of reverse osmosis (RO), rendering this energy-efficient technology inappropriate for the treatment of shale oil and gas wastewater (Shaffer D L et al. Environ. Sci. Technol. 2013, 47, 9569-9583; Tong T Z et al. Environ. Sci. Technol. 2016, 50, 6846-6855). Further, various organic contaminants have been identified in shale oil and gas wastewater, such as toxic and volatile compounds including benzene, toluene, ethylbenzene, and xylenes (BTEX) (Butkovskyi A et al. Environ. Sci. Technol 2017, 51, 4740-4754). The concentrations of BTEX present in shale oil and gas wastewater are typically in the mg/L levels (Butkovskyi A et al. Environ. Sci. Technol 2017, 51, 4740-4754; Khan N A et al. Chemosphere 2016, 148, 126-136; Rosenblum J et al. Environ. Sci. Technol. 2017, 51, 14006-14015), which are significantly higher than the typical National Pollutant Discharge Elimination System (NPDES) discharge limits (<100 μg/L) found in various local permits (Arkansas Department of Environmental Quality, Fact Sheet and Supplementary Information for General Permit Discharges from Groundwater and Surface Water Clean Up Located within the State of Arkansas, 2016; U.S. EPA, Technically-based Local Limits Development Strategy, 1995; U.S. EPA, Remediation General Permit Fact Sheet Excerpts, 2005, p. 2005). Recently, organic fractions from hydraulic fracturing flowback and produced water have been shown to impose significant toxicity to zebrafish embryos (He Y H et al. Environ. Sci. Technol. 2018, 52, 3820-3830). As a result, removal of toxic compounds from shale oil and gas wastewater is necessary prior to the discharge of treated wastewater into publicly owned treatment works or natural water bodies, as well as other reuse purposes (e.g., irrigation and non-potable municipal usage) (Pica N E et al. Ind. Crop. Prod. 2017, 100, 65-76; Dolan F C et al. Sci. Total Environ. 2018, 640-641, 619-628).

Membrane distillation (MD) is an emerging hybrid thermal-membrane desalination technology, which has recently attracted great attention in the treatment of hazardous and hypersaline wastewater (Deshmukh A et al. Energy Environ. Sci. 2018, 11, 1177-1196; Dudchenko A V et al. Nat. Nanotechnol. 2017, 12, 557-563). Membrane distillation tolerates high salinity of shale oil and gas wastewater while requiring lower temperature and capital costs than other thermal desalination technologies including mechanical vapor compression (MVC), multi-effect distillation (MED), and multi-stage flash (MSF) (Deshmukh A et al. Energy Environ. Sci. 2018, 11, 1177-1196). Membrane distillation is also capable of utilizing geothermal energy contained in the shale oil and gas wastewater (Shaffer D L et al. Environ. Sci. Technol. 2013, 47, 9569-9583), thereby reducing primary energy consumption, carbon footprint, and expenses of the treatment system. The modular nature of membrane distillation enables a compact and on-site treatment system adaptive to the fluctuation of wastewater volume during shale oil and gas production. Therefore, membrane distillation has been considered a promising and suitable technology for the treatment and reuse of shale oil and gas wastewater (Ali A et al. Desalination 2018, 434, 161-168; Boo C et al. Environ. Sci. Technol. 2016, 50, 12275-12282; Du X W et al. J. Membr. Sci. 2018, 567, 199-208; Kim J et al. Water Res. 2018, 129, 447-459; Kim J et al. Desalination 2017, 403, 172-178; Lokare O R et al. J. Membr. Sci. 2017, 524, 493-501; Tavakkoli S et al. Desalination 2017, 416, 24-34).

However, the performance of membrane distillation is largely constrained by membrane fouling and scaling, both of which reduce water vapor flux and energy efficiency of membrane distillation desalination (Warsinger D M et al. Desalination 2015, 356, 294-313; Tijing L D et al. J. Membr. Sci. 2015, 475, 215-244). Membrane fouling and scaling are particularly problematic for the treatment of shale oil and gas wastewater due to its high salinity and complex organic composition. Further, volatile and semi-volatile contaminants are able to transport through the microporous membrane distillation membranes, resulting in inferior rejection of those contaminants that greatly compromise the quality of distillated water product (Winglee J M et al. Environ. Sci. Technol. 2017, 51, 13113-13121). Coupling membrane distillation with appropriate pretreatment steps, which remove organic contaminants and inorganic scalants from the raw wastewater, has the potential to address the aforementioned issues, thereby significantly promoting practical applications of membrane distillation to wastewater treatment in the shale oil and gas industry.

Several studies have shown the use of softening and/or coagulation processes to remove both organic and inorganic constituents from shale possess exceptional efficiency in removing colloidal and suspended particles (up to 99% removal efficiency for turbidity) (Esmaeilirad N et al. J. Hazard. Mater. 2015, 283, 721-729; Lobo F L et al. J. Hazard. Mater. 2016, 309, 180-184; Zhai J et al. Environ. Technol. 2017, 38, 1200-1210), meanwhile decreasing the concentrations of diverse inorganic components in shale oil and gas produced water (Esmaeilirad N et al. J. Hazard. Mater. 2015, 283, 721-729). For example, Esmaeilirad et al. reported that a combination of softening and electrocoagulation was effective in removing turbidity and hardness from produced water, and the use of softening prior to electrocoagulation was favorable due to the formation of solids before the coagulation process (Esmaeilirad N et al. J. Hazard. Mater. 2015, 283, 721-729). Further, walnut shell filter media have been widely used in the treatment of oil-associated wastewater (Srinivasan A et al. Bioresour. Technol. 2008, 99, 8217-8220; Srinivasan A et al. Bioresour. Technol. 2010, 101, 6594-6600; Cakmakci M et al. Desalination 2008, 222, 176-186). Walnut shell is a naturally derived and inexpensive material, which has demonstrated high adsorption capacities for oil (Srinivasan A et al. Bioresour. Technol. 2008, 99, 8217-8220) and other toxic pollutants (e.g., organic dyes (Dahri M K et al. J. Environ. Chem. Eng. 2014, 2, 1434-1444) and heavy metals (Owlad M et al. Water Air Soil Pollut. 2009, 200, 59-77; Lesmana S O et al. Biochem. Eng. J. 2009, 44, 19-41; Almasi A et al. Toxicol. Environ. Chem. 2012, 94, 660-671)). Therefore, the aforementioned methods are simple and cost-effective candidates for pretreatment prior to the downstream treatment technologies such as membrane distillation. However, their coupling with membrane distillation has just emerged in the literature for the treatment of shale oil and gas wastewater. Recently, Sardari et al. combined electrocoagulation with membrane distillation to treat hydraulic fracturing produced water collected from the Marcellus shale (Sardari K et al. J. Membr. Sci. 2018, 564, 82-96). Their results demonstrated that pretreatment of produced water by electrocoagulation effectively reduced membrane fouling and resulted in stable water flux during long-term membrane distillation treatment (Sardari K et al. J. Membr. Sci. 2018, 564, 82-96). However, the effect of pretreatment on the quality of distillated water product was not reported therein (Sardari K et al. J. Membr. Sci. 2018, 564, 82-96).

In the current study, an integrated treatment train comprising precipitative softening (PS), walnut shell filtration (WSF), and membrane distillation (MD) in sequence was developed, which was used to treat the shale oil and gas produced water generated from the Wattenberg field in northeast Colorado. The efficiencies of the pretreatment steps (e.g., precipitative softening and walnut shell filtration) in removing a comprehensive set of organic and inorganic constituents were evaluated. The membrane distillation performance (in terms of both water vapor flux and distillate quality) with and without pretreatment was evaluated and compared in a laboratory-scale direct contact membrane distillation (DCMD) system. In addition, the reusability of membrane distillation membranes, a commercially available polyvinylidene fluoride (PVDF) membrane, was investigated during multiple treatment cycles integrated with membrane physical cleaning. It was demonstrated that a combined pretreatment of precipitative softening with walnut shell filtration greatly reduced the fouling and scaling potential of the produced water, leading to more stable membrane distillation performance and improved quality of distillated water product. These results highlight the potential of utilizing this treatment train to achieve cost- and energy-effective conversion of shale oil and gas wastewater into high quality water product appropriate for discharge and beneficial reuse purposes.

Materials and Methods

Materials, Chemicals, and Shale Oil and Gas Produced Water

Flat sheet polyvinylidene fluoride (PVDF) membranes (HVHP, Durapore) were provided by Millipore Sigma. According to the manufacturer, these microporous, hydrophobic membranes have a nominal pore size of 0.45 μm and an average thickness of 125 μm, which have been commonly used in membrane distillation desalination (Liao Y et al. J. Membr. Sci. 2013, 425, 30-39; Martinez L et al. Desalination 2001, 139, 373-379; Lawson K W et al. J. Membr. Sci. 1997, 124, 1-25). Aluminum sulfate octadecahydrate (Al₂(SO₄)₃.18H₂O) and sodium hydroxide (NaOH) were both purchased from VWR BDH Chemicals. Hydrochloric acid (HCl, 36.5-38%) was provided by Fisher Chemical. Blast media walnut shells with an average grain size of 1.6 mm were supplied by the Eastwood Company. Deionized (DI) water was produced from an ultrapure water purification system (≥18 MΩcm, Millipore).

Shale oil and gas produced water samples were collected on Mar. 21, 2018 from a production site located in the Wattenberg field of northeast Colorado. The well was drilled and hydraulically fractured with its flowback beginning on Oct. 24, 2017. The produced water was transported to a laboratory located at Colorado State University (Fort Collins, Colo.) within 2 h after collection and stored at 4° C. until use.

Precipitative Softening and Walnut Shell Filtration

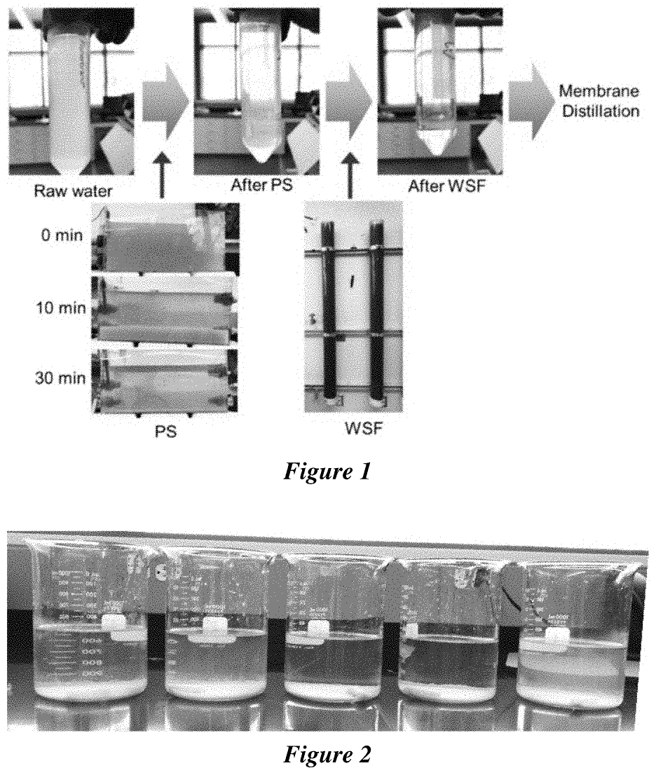

Shale oil and gas produced water (18 L) was placed in a rectangular container (50 cm in length, 20 cm in width, and 25 cm in depth, FIG. 1), and the pH was adjusted to ˜10 by adding NaOH or HCl solution (Esmaeilirad N et al. J. Hazard. Mater. 2015, 283, 721-729). Then a small of amount of Al₂(SO₄)₃.18H₂O (alum, 15 mg/L as coagulant) was added into the produced water to facilitate the precipitation process. Aluminum and ferric salts are the most common coagulants used in water treatment. However, in a previous study (Du X W et al. J. Membr. Sci. 2018, 567, 199-208), it was observed that the co-existence of silica and iron-associated scales formed on membranes after membrane distillation treatment of produced water collected from the same production site as this study. Also, iron is known to facilitate silica scaling in membrane desalination (Sahachaiyunta P et al. Desalination 2002, 144, 373-378; Li Z Y et al. Water Res. 2012, 46, 195-204). Therefore, alum, which has been used in the pretreatment of petroleum-associated produced water (Dastgheib S A et al. Int. J. Greenhouse Gas Control 2016, 54, 513-523), was selected in the current study to avoid enhanced membrane scaling. After mixing the produced water with Al₂(SO₄)₃ for 1 min at room temperature, the formed flocs were allowed to settle for 30 min. Then the supernatant was decanted into a clean polyethylene bucket for further treatment and analyses. Although optimization of the softening process was beyond the scope of the current study, a set of experimental conditions was tested herein, with the selected coagulant dose achieving the lowest turbidity of the supernatant (FIG. 2). As shown in FIG. 2, a high pH of 10 was able to induce significant precipitation in the produced water, and the addition of small amount of alum was used to facilitate the coagulation and flocculation of the precipitates to promote removal through settling. The collected supernatant was either used as the influent in the following walnut shell filtration or stored in 4° C. for future analyses and membrane distillation desalination tests.

Two cylindrical filter columns (10.4 cm in diameter and 103.5 cm in height) were packed with walnut shells and used to treat the produced water after precipitative softening (FIG. 1). The filter columns were cleaned and stabilized by filtering 50 L of deionized water per day for 10 days. The produced water was filtered by these two filter columns in sequence at a constant flow rate of 4.5 L/min, and the filtered solution was collected into a clean polyethylene bucket and stored at 4° C. for future analyses and membrane distillation desalination tests.

Treatment of Shale Oil and Gas Produced Water by Membrane Distillation

Shale oil and gas produced water with and without pretreatment was treated in a laboratory-scale, custom-built direct contact membrane distillation unit equipped with a transparent acrylic flow cell. The feedwater and distillate channels of the flow cell had a dimension of 77 mm×26 mm×3 mm, corresponding to an effective membrane area of 20.02 cm². Three types of produced water were used as membrane distillation feedwater: (1) raw produced water without any pretreatment; (2) produced water pretreated by only precipitative softening; (3) produced water pretreated by both precipitative softening and walnut shell filtration. The produced water (2000 mL) was placed in the reservoir of feed solution, while deionized water (600 mL) was added into the reservoir of distillate. The hot feed and cold distillate streams were circulated using two variable gear pumps (Cole-Parmer), and the temperatures were maintained at 60° C. (feed) and 20° C. (distillate), respectively. The crossflow velocities of the feed and distillate streams were 8.5 cm/s (0.4 L/min) and 7.4 cm/s (0.35 L/min), respectively. The mass and conductivity of the solution in the distillate reservoir were monitored continuously in order to calculate the water vapor flux and assess membrane wetting. When 1650 mL of distillate was collected (corresponding to a water recovery of 82.5%), the direct contact membrane distillation tests were terminated to complete one treatment cycle. A higher water recovery could be reached in these experiments, but a maximum water recovery of 82.5% was used to protect the gear pump from potential damage by the highly concentrated brine.

Fouling Reversibility and Membrane Reusability after Physical Cleaning

Fouling reversibility and membrane reusability were evaluated within three continuous treatment cycles, in which the produced water pretreated by both precipitative softening and walnut shell filtration was used as the feed solution. After collecting 1650 mL of distillate (i.e., one full treatment cycle), the membrane coupon was taken out of the flow cell and rinsed thoroughly with deionized water (2 L/min, for 20 s) on both sides. This physical cleaning procedure removed inorganic and organic foulants that were loosely attached to the membrane surface. The membrane coupon was then reinserted into the direct contact membrane distillation unit after being dried in air, and 2000 mL of new pretreated produced water was added into the feed reservoir to start another direct contact membrane distillation treatment cycle. The initial water vapor fluxes and flux decline rates in different treatment cycles were measured and compared.

Water Quality Analysis

The chemical compositions of the produced water and membrane distillation distillate were analyzed in detail by a third party and certified laboratory (Technology Laboratory, Inc., Fort Collins, Colo.). Twenty four (24) parameters measured and compared between produced waters with and without pretreatment. Those parameters include seventeen (17) inorganic constituents (alkalinity, chloride, conductivity, dissolved aluminum, dissolved barium, dissolved boron, dissolved calcium, dissolved iron, dissolved magnesium, dissolved silica, dissolved sodium, dissolved strontium, pH, sulfate, sulfide, total dissolved solids, and turbidity), which were closely associated with salinity and scaling potential of the produced water. A set of organic constituents (seven parameters), including BTEX (containing four organic compounds), total organic carbon (TOC), total recoverable petroleum hydrocarbons (TRPH), and total volatile petroleum hydrocarbons (TVPH), were also measured to represent the contents of organic foulants and contaminants. All the measurements were performed following standard methods (Clescerl L S et al. Standard Methods for Examination of Water & Wastewater, 20th edition, American Public Health Association/American Water Works Association/Water Environment Federation, Washington D.C., 1998), and stringent quality control was provided by Technology Laboratory, Inc. The scaling potential of the produced water with and without pretreatment was estimated by thermodynamic calculation using the software PHREEQC and the database MINTEQ (version 4) (Parkhurst D et al. User's guide to PHREEQC (version 2)—a computer program for speciation, batch-reaction, one-dimensional transport, and inverse geochemical calculations, U.S. Geological Survey Water-Resources Investigations Report, 1999, pp. 99-4259; Tong T Z et al. Environ. Sci. Technol. 2014, 48, 7924-7932).

Among the twenty-four aforementioned parameters, eight parameters (BTEX, conductivity, dissolved boron, total recoverable petroleum hydrocarbons, total volatile petroleum hydrocarbons) were measured for the distillated water product of membrane distillation treatment. The conductivity of water product indicates the salt removal efficiency of membrane distillation desalination, while BTEX, total recoverable petroleum hydrocarbons, and total volatile petroleum hydrocarbons represent typical organic contaminants that potentially transport into the membrane distillation distillate. The concentration of dissolved boron was selected because borate is commonly used in fracturing fluids (Li L et al. Petroleum 2016, 2, 313-323) and its presence in produced water has attracted attention by shale oil and gas companies (personal communication with Halliburton Company). Considering 600 mL of deionized water was originally placed in the distillate reservoir and 1650 mL (for produced water after pretreatment by precipitative softening and/or walnut shell filtration) or 800 mL (for raw produced water) of distillate was collected during membrane distillation desalination, the measured values of those eight (8) parameters were adjusted by multiplying by a factor of 1.36 or 1.75.

Results and Discussion

Pretreatment Efficiencies in Removing Inorganic and Organic Constituents of Shale Oil and Gas Produced Water

The influences of pretreatment steps (e.g., precipitative softening followed by walnut shell filtration) on twenty four (24) inorganic and organic constituents of shale oil and gas produced water were evaluated. As shown in Table 1, precipitative softening effectively reduced the turbidity of produced water by 94%, as indicated by the much clearer softening supernatant compared to the raw produced water (FIG. 1). Precipitative softening also decreased the concentrations of multiple scale-forming species, as the concentrations of alkalinity, dissolved barium (Ba), calcium (Ca), magnesium (Mg), silica, and strontium (Sr) dropped by 45%, 48%, 46%, 19%, 32%, and 20%, respectively. These scale-forming species were responsible for a wide spectrum of mineral scales occurring in membrane desalination (e.g., barium sulfate, calcite, gypsum, silica, and strontium carbonate) (Antony A et al. J. Membr. Sci. 2011, 383, 1-16; Cheng W et al. J. Membr. Sci. 2018, 559, 98-106; Rahardianto A et al. J. Membr. Sci. 2007, 289, 123-137; Tong T Z et al. Environ. Sci. Technol. 2017, 51, 4396-4406), indicating that precipitative softening reduced scaling potential of the produced water. Thermodynamic calculation indicated that with pH of 10 and a relatively high concentration of alkalinity (5.5 mM), dissolved Ca could be removed by forming sparingly soluble calcite (CaCO₃), while dissolved Sr and Ba were precipitated in the forms of strontianite (SrCO₃) and witherite (BaCO₃). Also, the observed removal of silica was likely due to its co-precipitation with aluminum salts, which are well-known reagents for silica removal (Masarwa A et al. Desalination 1997, 113, 73-84). The partial removal of dissolved Mg was consistent with what was reported by Esmaeilirad et al. (Esmaeilirad N et al. J. Hazard. Mater. 2015, 283, 721-729), because pH of 10 was insufficient for significant Mg softening (requiring pH>11).

However, precipitative softening was ineffective in removing boron from the produced water (only 5% removal efficiency) (Table 1). At the experimental pH, boron was in the forms of borate ions (B(OH)₄⁻, dominant species) and boric acid (B(OH)₃) (Oo M H et al. Desalination 2009, 246, 605-612; Tu K L et al. Chem. Eng. J. 2011, 168, 700-706), both of which were unable to form removable precipitates during the softening process.

Furthermore, precipitative softening was also able to remove multiple organic contaminants (Table 1). The concentrations of total organic carbon (TOC), total recoverable petroleum hydrocarbons (TRPH), and total volatile petroleum hydrocarbons (TVPH) were reduced by 39%, 44%, and 9%, respectively, while the contents of BTEX were decreased by 7%-45% depending on the specific compound. Since softening was not intentionally designed to remove organic matter, the observed removal of organic substances was mainly because of their adsorption onto the precipitates formed during softening (Randtke S J. J. Am. Water Works Assoc. 1988, 80, 40-56). Due to the chemical complexity of the produced water, the mechanisms underlying the variation of removal efficiency for different organic contaminants are still not fully understood and require further investigation. The higher removal efficiencies for ethylbenzene and total xylenes (32%-45%) compared to benzene and toluene (7%-9%) were likely attributed to their higher octanol/water partition coefficients (K_{ow}) (Table 2).

TABLE 1
Inorganic and organic composition of shale oil and gas
produced water with and without pretreatment steps.

| | Raw Water | After PS | After WSF | 1-2 | 2-3 | 1-3 |
|---|---|---|---|---|---|---|
| Parameter | (mg/L) | (mg/L) | (mg/L) | change | change | change |
| Alkalinity | 555 | 306 | 183 | 45% | 40% | 67% |
| Dissolved aluminum | 10.9 | 6.92 | 6.95 | 37% | 0% | 36% |
| Dissolved barium | 42.1 | 21.8 | 14.7 | 48% | 33% | 65% |
| Dissolved boron | 32.9 | 31.1 | 10.6 | 5% | 66% | 68% |
| Dissolved calcium | 878 | 470 | 601 | 46% | −28% | 32% |
| Chloride | 23292 | 20901 | 16724 | 10% | 20% | 28% |
| Dissolved iron | <0.007 | <0.007 | <0.007 | N/A | N/A | N/A |
| Dissolved magnesium | 129 | 105 | 102 | 19% | 3% | 21% |
| Dissolved silica | 26.1 | 17.7 | 11.9 | 32% | 33% | 54% |
| Dissolved sodium | 11000 | 11100 | 8760 | −1% | 21% | 20% |
| Dissolved strontium | 99.7 | 79.7 | 55.7 | 20% | 30% | 44% |
| Sulfate | <0.05 | <0.05 | <0.05 | N/A | N/A | N/A |
| Sulfide | 0.081 | 0.1 | 0.094 | −23% | 6% | −16% |
| TDS | 41420 | 37290 | 31290 | 10% | 16% | 24% |
| TOC | 720 | 440 | 540 | 39% | −23% | 25% |
| TVPH | 55.8 | 50.8 | 4.1 | 9% | 92% | 93% |
| TRPH | 70.9 | 39.8 | 11.2 | 44% | 72% | 84% |
| Benzene | 9 | 8.38 | 0.412 | 7% | 95% | 95% |
| Toluene | 4.29 | 3.89 | 0.103 | 9% | 97% | 98% |
| Ethylbenzene | 0.479 | 0.327 | 0.009 | 32% | 97% | 98% |
| Total Xylenes | 1.67 | 0.911 | 0.034 | 45% | 96% | 98% |
| | | | | 1-2 | 2-3 | 1-3 |
| Parameter | Raw Water | After PS | After WSF | change | change | change |
| Turbidity | 322 NTU | 20.1 NTU | 18.1 NTU | 94% | 10% | 94% |
| pH | 6.6 units | 9.72 units | 5.77 units | N/A | N/A | N/A |

TABLE 2
Molecular weights and octanol-water partition
coefficients of BTEX compounds^{a}

| Compound | Benzene | Toluene | Ethylbenzene | Xylene ^{b} |
|---|---|---|---|---|
| Molecular weight (g/mol) | 78 | 92 | 106 | 106 |
| Log K_{ow} | 2.13 | 2.69 | 3.15 | 2.77-3.15 |

^{a}Resource: EUGRIS (European groundwater and contaminated land remediation information system) http://www.eugris.info/FurtherDescription.asp?e=6&Ca=2&Cy=0&T=.
^{b} Xylene includes o-Xylene, m-Xylene, and p-Xylene, which possess different Log K_{ow} values.

Walnut shell filtration was employed to further reduce the levels of organic contaminants present in the produced water after precipitative softening. This naturally derived approach notably removed >95% of BTEX (Table 1) from the feedwater, thereby substantially reducing the potential of these toxic and volatile compounds in penetrating into the distillated water product of the membrane distillation process. Walnut shell filtration also removed 66% of boron from the incoming produced water, and further reduced the concentrations of all the scale-forming species except for dissolved calcium. The removal of inorganic constituents by walnut shell filtration was likely due to adsorption, and future investigation (e.g., on adsorption isotherms and binding of specific ions with walnut shells) is needed to elucidate the mechanisms and selectivity of inorganic removal by walnut shell filtration. The increase of calcium concentrations and total organic carbon (TOC) in the walnut shell filtrate was probably due to the release of calcium ions and organic substances from the walnut shell media. After pretreatment with a combination of precipitative softening and walnut shell filtration, the fouling and scaling potential of the produced water was significantly reduced. Considering a water recovery of 80%, thermodynamic calculations showed that the saturation indices (defined as the common logarithm (log₁₀) of the ratio of ion activity product to solubility product) of calcite, silica, and strontianite were decreased from 1.25, 0.37, and 0.62 in the raw produced water to 0.03, −0.14, and −0.70 in the pretreated produced water.

Membrane Distillation Performance in the Treatment of Shale Oil and Gas Produced Water within a Single Cycle

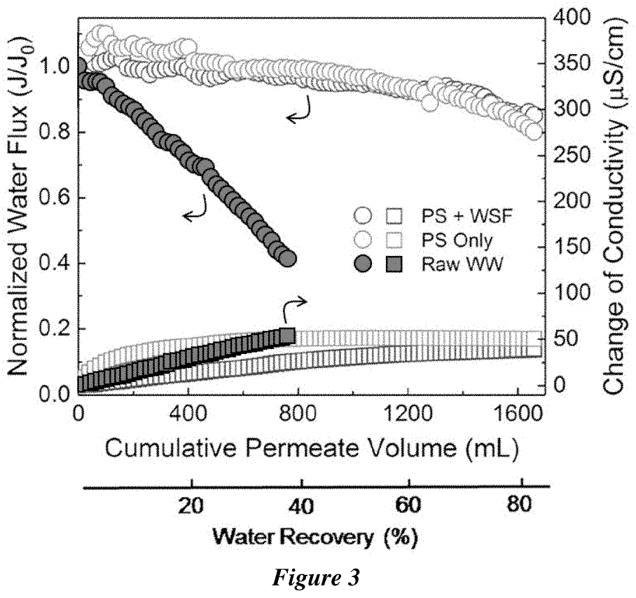

The shale oil and gas produced water with and without pretreatment was desalinated by direct contact membrane distillation using a commercially available polyvinylidene fluoride membrane. FIG. 3 presents the normalized water vapor fluxes (left axis, circular data points) in the direct contact membrane distillation treatment of different produced water in a single cycle. When the raw produced water without any pretreatment was used as the membrane distillation feedwater, the water vapor flux decreased rapidly by ˜60% at a water recovery of only 40% (i.e., collecting 800 mL of distillate). The high concentrations of suspended solids, organic foulants, and inorganic scalants present in the raw produced water caused severe fouling and scaling on the membrane surface, which blocked membrane pores and increased membrane resistance to water vapor transport.

When pretreatment was applied, membrane distillation demonstrated much more stable water productivity and achieved higher water recoveries. The water flux was reduced by only ˜18% at a water recovery of 82.5% (i.e., collecting 1650 mL of distillate, FIG. 3), when precipitative softening was employed as the only pretreatment step. At this point, the total dissolved solids of membrane distillation concentrate was as high as 213,000 mg/L (initial total dissolved solids of produced water at 37,290 mg/L, Table 1), which exceeded the salinity limit of reverse osmosis significantly and was comparable to those of concentrated brines generated by mechanical vapor compression (MVC) and thermolytic forward osmosis (FO) (Tong T Z et al. Environ. Sci. Technol. 2016, 50, 6846-6855). This remarkable improvement of membrane distillation performance was due to the effectiveness of precipitative softening in reducing both fouling and scaling potential of the produced water (Table 1).

When walnut shell filtration was performed following precipitative softening, membrane distillation exhibited the most stable water productivity, with the water vapor flux dropping by only ˜10% at a water recovery of 82.5% (the total dissolved solids of membrane distillation brine was ˜180,000 mg/L, considering the initial total dissolved solids of the pretreated produced water at 31,290 mg/L). Since the activity of water in NaCl solution was 0.88 at NaCl concentration of 3M (with similar total dissolved solids as the membrane distillation brine used herein) (Hubert N et al. J. Chem. Eng. Data 1995, 40, 891-894; Al-Obaidani S et al. J. Membr. Sci. 2008, 323, 85-98), this decrease of water flux was mainly due to the increase in salinity of the membrane distillation feedwater (which reduced solution vapor pressure) rather than membrane fouling and scaling. Therefore, these results demonstrated that coupling membrane distillation with appropriate pretreatment steps (e.g., precipitative softening and walnut shell filtration in the current study) is an adequate and valuable approach to mitigate membrane fouling and scaling in membrane distillation desalination of shale oil and gas produced water, thereby increasing both water productivity and membrane lifespans effectively.

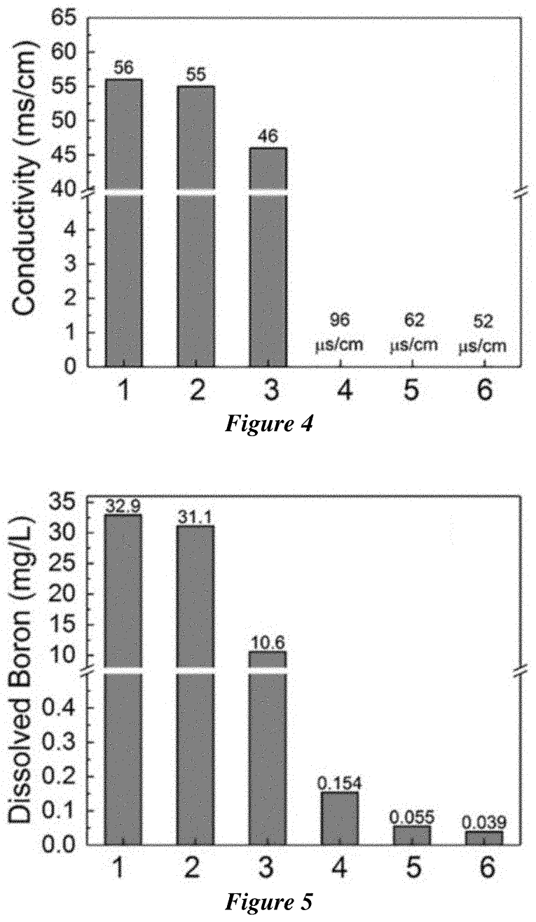

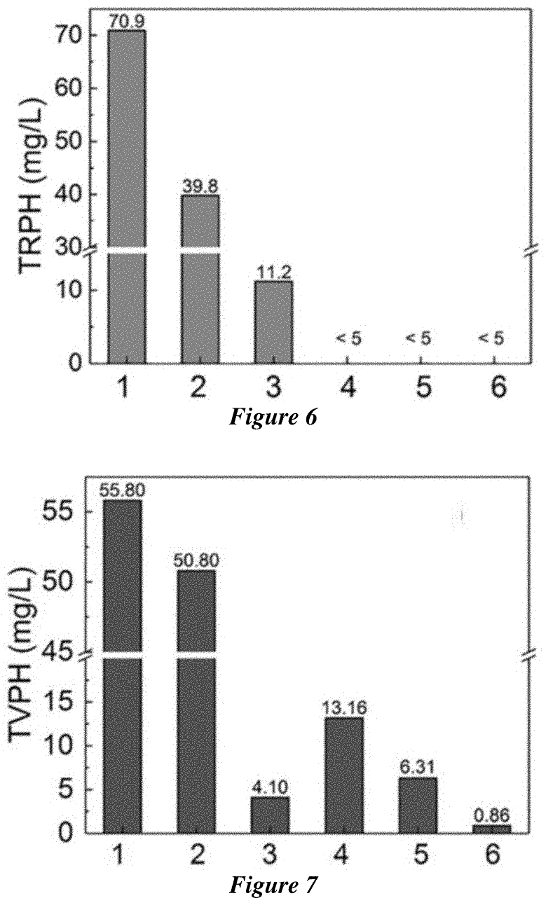

The water qualities of membrane distillation distillate were analyzed and compared among experimental conditions with and without pretreatment of produced water. Regardless of the prior pretreatment steps, membrane distillation demonstrated excellent rejection of salt and boron. The conductivities of the distillated water product were increased by ˜30-50 μS/cm (FIG. 3, right axis, square data points, and FIG. 4) at the conclusion of the direct contact membrane distillation tests. This increase corresponded to conductivities of ˜50-90 μS/cm in the membrane distillation permeate, which were three orders of magnitudes lower than that of the untreated produced water (40-50 mS/cm). Hence, no significant membrane wetting occurred in this study. Since neither borate ions nor boric acids are volatile, membrane distillation was able to effectively remove >99.5% of boron (FIG. 5) from the produced water. This exceptional removal efficiency was higher than that of reverse osmosis (the boron rejection by single-pass reverse osmosis in seawater desalination has been reported to be ˜90% at near neutral pH (Werber J R et al. Environ. Sci. Technol. Lett. 2016, 3, 112-120)). The concentrations of boron in the membrane distillation distillate (0.04-0.15 mg/L, depending on the applied pretreatment steps) met the regulation standard required for irrigation (<0.5 mg/L) (Werber J R et al. Environ. Sci. Technol. Lett. 2016, 3, 112-120; Shaffer D L et al. J. Membr. Sci. 2012, 415, 1-8). In addition, the total recoverable petroleum hydrocarbons concentrations were below the detection limit of 5 mg/L after membrane distillation treatment (FIG. 6), despite a high total recoverable petroleum hydrocarbons concentration of 70 mg/L in the raw produced water.

Since volatile contaminants are able to transport through microporous membranes along with water vapor during the membrane distillation process, the concentrations of total volatile petroleum hydrocarbons and BTEX were measured to assess the environmental and health risks of the distillated water product. As shown in FIG. 7, 23.6% of volatile petroleum hydrocarbons from the raw produced water was able to penetrate through the polyvinylidene fluoride membrane, resulting in a total volatile petroleum hydrocarbons concentration of ˜13 mg/L in the membrane distillation water product. The employment of pretreatment steps reduced the concentrations of total volatile petroleum hydrocarbons in the membrane distillation distillate significantly. The concentration of total volatile petroleum hydrocarbons dropped to ˜6 mg/L in the distillate when precipitative softening was used, and additional pretreatment using walnut shell filtration further decreased the total volatile petroleum hydrocarbons concentration to only 0.9 mg/L.

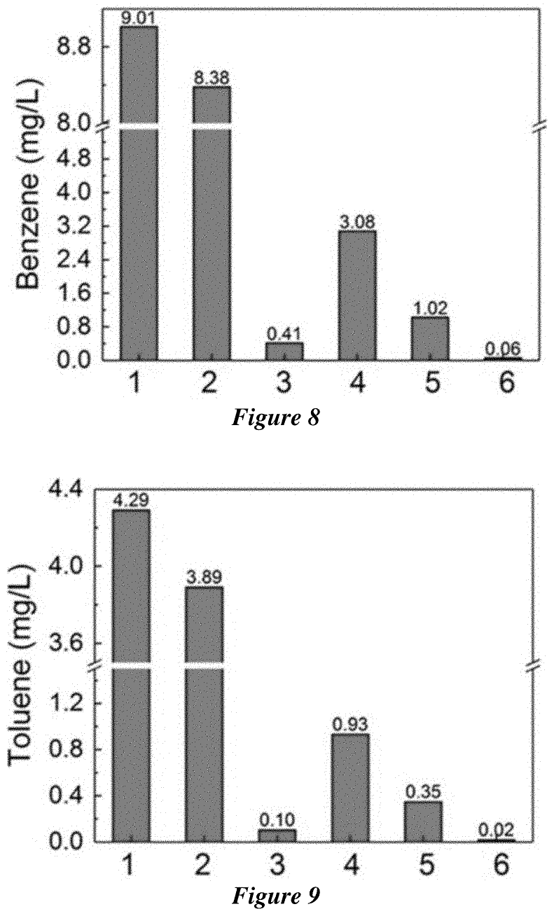

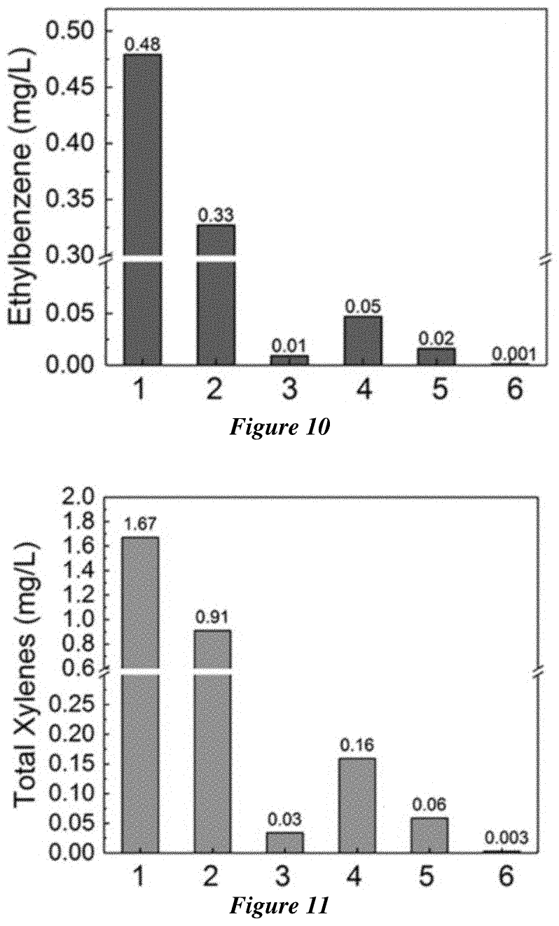

The same trend was observed in the removal of BTEX (FIG. 8-FIG. 11). In the membrane distillation treatment of raw produced water, the concentrations of benzene, ethylbenzene, toluene, and xylenes in the distillate were 3.08 mg/L, 0.93 mg/L, 0.05 mg/L, and 0.16 mg/L, corresponding to 34.2%, 21.7%, 10.4%, and 9.6% of the compounds passing through the direct contact membrane distillation system, respectively. Those concentrations were much higher than the typical local discharge limit (100 μg/L of total BTEX) regulated by the National Pollutant Discharge Elimination System, indicating that membrane distillation treatment alone was unable to generate water product suitable to be discharged into the publicly owned treatment works. When precipitative softening was applied prior to membrane distillation desalination, the concentrations of benzene, ethylbenzene, toluene, and xylenes in the membrane distillation distillate dropped by ˜60% to 1.02 mg/L, 0.35 mg/L, 0.02 mg/L, and 0.06 mg/L, respectively. Walnut shell filtration, which demonstrated exceptional efficiencies in adsorbing BTEX (>95%, Table 1), further decreased the BTEX concentrations to ultra-low levels (0.001 mg/L-0.06 mg/L), with total BTEX concentration meeting the typical National Pollutant Discharge Elimination System discharge limit (<100 μg/L).

These results are among the first to reveal the concentrations of representative volatile contaminants in the distillated products of membrane distillation desalination of shale oil and gas produced water. Along with the results of total volatile petroleum hydrocarbons as mentioned before, a combination of precipitative softening and walnut shell filtration as pretreatment was shown to effectively prevent the intrusion of those volatile contaminants into the distillate of the membrane distillation process, thereby largely reducing the potential environmental and health risks of the treated wastewater.

Fouling Reversibility and Membrane Reusability within Multiple Treatment Cycles

Fouling reversibility and membrane reusability of the membrane distillation treatment were investigated within three consecutive treatment cycles, in order to evaluate long-term membrane distillation performance for produced water treatment. A recent study demonstrated the importance of evaluating membrane reusability, not only membrane fouling and wetting, in the assessment of membrane performance in the membrane distillation process (Du X W et al. J. Membr. Sci. 2018, 567, 199-208). The produced water pretreated by both precipitative softening and walnut shell filtration was used as the membrane distillation feedwater because it led to the most stable water vapor flux and the best water product quality (FIG. 3-FIG. 11). Physical membrane cleaning was performed after each treatment cycle (i.e., collecting 1650 mL of distillate with a water recovery of 82.5%).

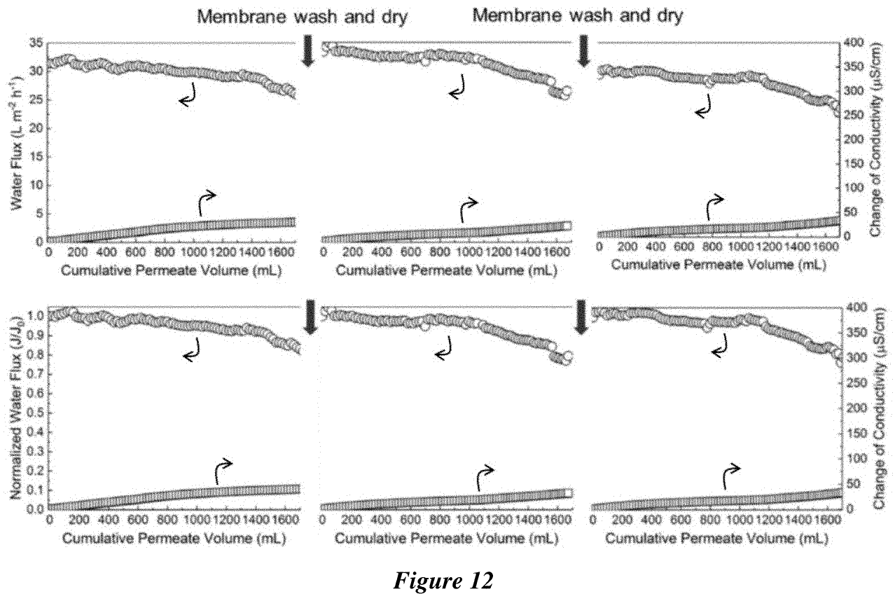

As shown in FIG. 12, the water productivity of membrane distillation treatment remained relatively stable within the three treatment cycles, with a water flux decline of <20% observed for every cycle (FIG. 12, circular data points, left axis, top and bottom panels). The water vapor flux was fully restored after physical cleaning regardless of the treatment cycles (FIG. 12, circular data points, left axis, top and bottom panels). Further, the change of conductivity in the membrane distillation distillate remained at low levels (<50 μS/cm) for all the treatment cycles (FIG. 12, square data points, right axis, top and bottom panels), which corresponded to consistent salt rejection rates of >99.8%. Hence, no significant membrane wetting was observed during the three treatment cycles. The above results indicate that the treatment train was able to achieve high water recoveries (>80%, with membrane distillation concentrate total dissolved solids of −180,000 mg/L) during multiple runs of membrane distillation desalination of shale oil and gas produced water, and the polyvinylidene fluoride membranes used in the current study were reusable after applying a simple cleaning procedure.

Implications for Shale Oil and Gas Produced Water Treatment

Shale oil and gas wastewater treatment represents a major challenge facing unconventional energy exploitation. Although membrane distillation has shown great promise to desalinate and treat this special wastewater, its application is constrained by membrane fouling and scaling (Warsinger D M et al. Desalination 2015, 356, 294-313; Tijing L D et al. J. Membr. Sci. 2015, 475, 215-244) as well as its low capability of rejecting volatile contaminants (Winglee J M et al. Environ. Sci. Technol. 2017, 51, 13113-13121). In the current study, the combination of two pretreatment steps (e.g., precipitative softening and walnut shell filtration) provided a feasible solution to these critical issues. Precipitative softening reduced fouling and scaling potential of the produced water, and the walnut shell filtration further removed toxic contaminants due to its high adsorption capacity. Compared to the raw produced water that caused severe membrane fouling and water flux decline (FIG. 3), the pretreated produced water led to remarkably more stable and robust membrane distillation performance while achieving higher water recoveries. This improvement would effectively enhance water production, reduce the requirement of periodic membrane cleaning, and extend membrane lifetime during the membrane distillation process, thereby promoting the cost- and energy-efficiency of the wastewater treatment system. A pilot-scale system based on the treatment train reported in the current study is being built, and the longer-term performance of the treatment system (e.g., the frequencies of cleaning for walnut shell media and membrane replacement for membrane distillation) will be evaluated.

Furthermore, previous studies on membrane treatment of shale oil and gas wastewater primarily focused on water productivity (i.e., water flux) and the behavior of membrane fouling and scaling (Kim J et al. Desalination 2017, 403, 172-178; Lokare O R et al. J. Membr. Sci. 2017, 524, 493-501; Sardari K et al. J. Membr. Sci. 2018, 564, 82-96; Xiong B Y et al. Water Res. 2016, 99, 162-170). Even though the quality of the treated water products determines the suitability of their downstream applications (e.g., discharge into publicly owned treatment works or natural water body, reuse for irrigation or non-potable municipal usage), this aspect of treatment has not received attention from researchers until recently (Winglee J M et al. Environ. Sci. Technol. 2017, 51, 13113-13121; Bell E A et al. J. Membr. Sci. 2017, 525, 77-88). For example, the reuse of shale oil and gas produced water for agricultural irrigation has been proposed as a promising means to mitigate local freshwater scarcity (Pica N E et al. Ind. Crop. Prod. 2017, 100, 65-76; Dolan F C et al. Sci. Total Environ. 2018, 640-641, 619-628). Due to the sensitivity of crops to water quality and the close association of irrigation with environmental and public health, the chemical composition of the reused wastewater must meet rigorous regulations and standards (Lyu S D et al. J. Environ. Sci. (China) 2016, 39, 86-96; Quist-Jensen C A et al. Desalination 2015, 364, 17-32). Similarly, stringent water quality standards, which regulate the maximum permitted concentrations of pollutants, need to be met if the treated wastewater is discharged into either publicly owned treatment works or natural water bodies (U.S. EPA, Technically-based Local Limits Development Strategy, 1995; U.S. EPA, Remediation General Permit Fact Sheet Excerpts, 2005, p. 2005; Lester Y et al. Sci. Total Environ. 2015, 512, 637-644). In this study, although membrane distillation possessed exceptional salt removal efficiency, the distillated water product still contained high levels of volatile organic contaminants if no pretreatment was applied (FIG. 4-FIG. 11), consistent with the concerns recently raised by Winglee et al. that membrane distillation treatment of produced waters might require additional processing to meet discharge requirements due to the transport of volatile contaminants through the membrane distillation system (Winglee J M et al. Environ. Sci. Technol. 2017, 51, 13113-13121). Along with the high fouling and scaling potential of raw produced water (FIG. 3), the results herein highlight the necessity of combining membrane distillation with proper pretreatment steps to improve the performance of membrane distillation desalination and the quality of distillated water product. The treatment train described herein has demonstrated promising results for removing both boron and volatile organic contaminants (e.g., total volatile petroleum hydrocarbons and BTEX). A more comprehensive assessment, which includes a wider spectrum of parameters (e.g., heavy metals and radioactive materials), is ongoing to further evaluate the environmental and health risks of the treated water.

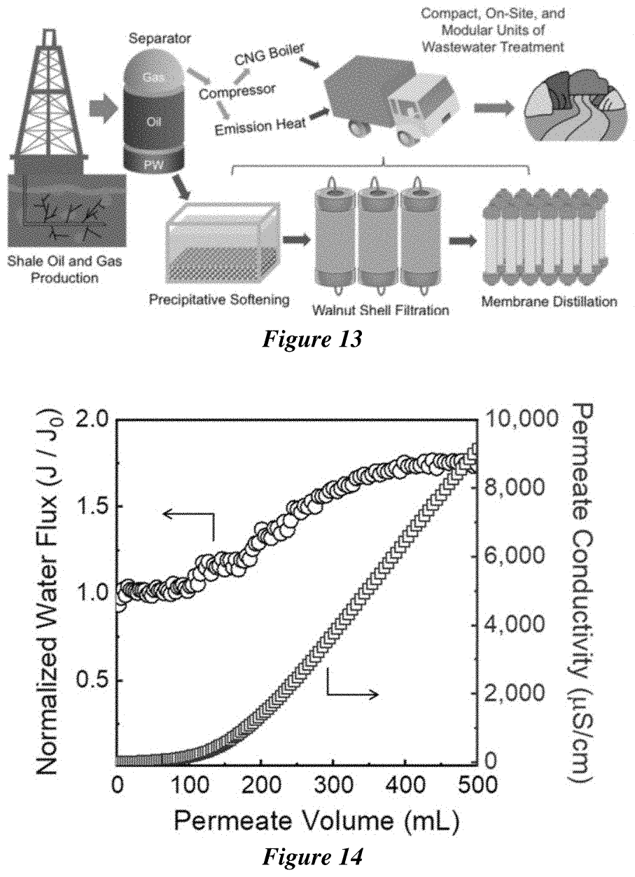

Finally, the membrane distillation process and the two pretreatment approaches used in this study are all compact and modular, potentially leading to an onsite and mobile wastewater treatment package tailored to the shale oil and gas industry (FIG. 13). Membrane distillation enables the utilization of low-grade energy (e.g., geothermal energy) contained in the shale oil and gas wastewater. Also, inexpensive energy resources such as natural gas are abundantly available in the oilfield, which could be used to heat the wastewater to the required temperature for the membrane distillation process using a simple compressed natural gas boiler. Thus, the energy consumption of the treatment train can be mostly self-sustained at the shale oil and gas production sites, minimizing the primary energy (e.g., electricity) consumption and the corresponding CO₂ footprint. The treatment train can be supplied as an integrated package transported by a mobile trailer, achieving adjustable and on-site treatment that would markedly reduce the transportation costs associated with wastewater management for shale oil and gas production. This integrated wastewater treatment system can improve the cost efficiency and feasibility of wastewater treatment and reuse in the shale oil and gas industry, and ultimately promote sustainability of unconventional energy exploitation at the water-energy nexus.

Conclusions

In this study, an integrated treatment train, which coupled membrane distillation with precipitative softening and walnut shell filtration as pretreatment steps, was developed to treat shale oil and gas produced water generated from the Wattenberg field in northeast Colorado. Precipitative softening decreased the concentrations of particulate, organic, and inorganic foulants, thereby reducing fouling and scaling potential of the produced water. Walnut shell filtration, a naturally derived approach, removed ≥95% volatile toxic contaminants such as BTEX, effectively preventing their intrusion into the distillated water product. Compared to the raw produced water, the pretreated produced water resulted in a remarkably more stable water vapor flux during membrane distillation desalination. Although membrane distillation demonstrated exceptional rejection of non-volatile constituents of the produced water (e.g., salts, boron, and non-volatile organics), volatile organic pollutants were able to transport through the membrane distillation membranes and compromise the quality of distillated water product. A combination of precipitative softening and walnut shell filtration substantially decreased the contents of volatile organic contaminants in the membrane distillation permeate, reducing the total BTEX concentration to a level below the typical National Pollutant Discharge Elimination System discharge limit. Membrane distillation treatment of the pretreated produced water also exhibited robust performance during three consecutive treatment cycles, each of which achieved total water recovery of >80% (total dissolved solids of membrane distillation brine at ˜180,000 mg/L). Therefore, it was demonstrated that membrane distillation in tandem with pretreatment is a promising strategy to treat shale oil and gas produced water effectively. Based on these technologies, an on-site and mobile system can be developed to reduce the energy consumption and costs of shale oil and gas wastewater treatment, thereby improving the sustainability of unconventional energy exploitation at the water-energy nexus.

### Example 2—Membrane Distillation Performance in the Treatment of Unconventional Oil and Gas Wastewater

Described herein is membrane distillation performance in the treatment of unconventional oil and gas wastewater. The results indicate that membrane wetting was prevented.

Unconventional oil and gas (UOG) wastewater from Denver-Julesburg (DJ) Basin (located in the state of Colorado) was collected and its water quality characteristics are found in Table 3. This unconventional oil and gas wastewater is different from that used in Example 1.

TABLE 3
Denver-Julesburg Basin unconventional oil and
gas wastewater characteristics.

| Characteristic | Units (mg/L) |
|---|---|
| Total Dissolved Solids (TDS) | 34,358 |
| Total Organic Carbon (TOC) | 390 |
| Gasoline Range Organics (GRO) - | 0.78 |
| Total Volatile Petroleum Hydrocarbons (TVPH) | |
| Oil & Grease | 37.6 |

This unconventional oil and gas wastewater was desalinated by direct contact membrane distillation (DCMD) with and without pretreatment using a commercially available polyvinylidene fluoride (PVDF) membrane. The pretreatment steps comprised coagulation with ferric chloride (FeCl₃, 25 mg/L) and walnut shell filtration.

A coagulant dose was optimized using a series of jar tests with doses from 25-150 mg/L of FeCl₃. Turbidity removal percentage ranged from ˜90% (for 25 mg/L FeCl₃) to 98% (for 100 mg/L FeCl₃). Although higher FeCl₃ doses could achieve higher turbidity removal, a coagulant dose of 25 mg/L FeCl₃ was selected due to its satisfying turbidity removal percentage and to minimize coagulant amount needed for effective coagulation. This result indicates that the selection of pretreatment (coagulation or precipitative softening) can be tailored to the quality of produced water. Coagulation can be preferable because it avoids the use of corrosive NaOH.

Membrane distillation performance was quantified based on normalized water (vapor) flux and permeate conductivity (μS/cm). Significant membrane wetting was observed with membrane distillation treatment of unconventional oil and gas wastewater without any type of pretreatment (FIG. 14). The permeate conductivity rapidly increased from ˜20 μS/cm to more than 9,000 μS/cm (FIG. 14, right axis, square data points) with a corresponding increase in the normalized water (vapor) flux from 1 to 1.75 (FIG. 14, left axis, circular data points). This is indicative of membrane wetting caused by low-surface-tension molecules (such as surfactants and other amphiphilic organics) present in the unconventional oil and gas wastewater, which allowed for the direct permeation of feed water (rather than only water vapor) into the permeate stream and significantly undermining salt rejection rate.

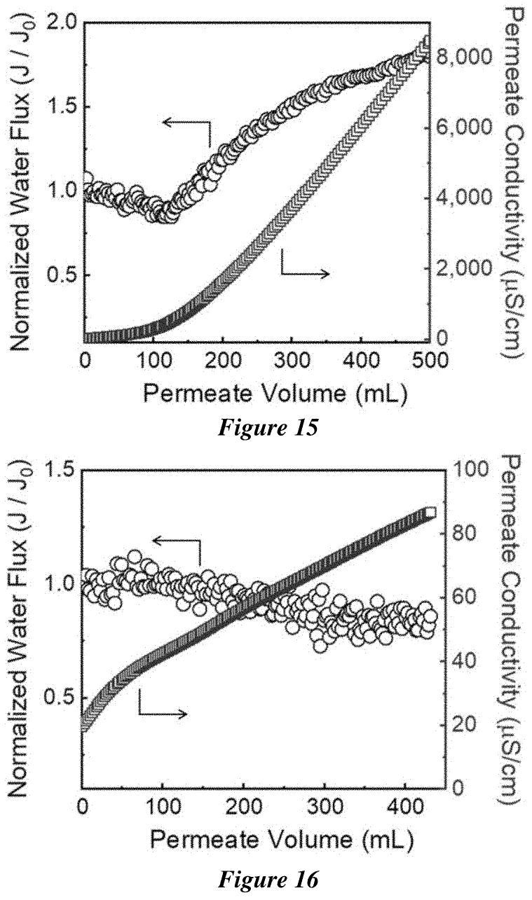

Pretreatment via coagulation with 25 mg/L of FeCl₃ was applied to determine its effectiveness of mitigating membrane wetting. With only coagulation, significant membrane wetting occurred with permeate conductivity increasing to more than 8,000 μS/cm (FIG. 15, right axis, square data points). The normalized water (vapor) flux initially decreased to ˜0.80 after recovering 100 mL of permeate, indicative of membrane fouling (FIG. 15, left axis, circular data points). However, the normalized water (vapor) flux rapidly increased to ˜1.75 consistent with membrane wetting (FIG. 15, left axis, circular data points). This indicates that pretreatment via coagulation was not able to prevent membrane wetting.

When both coagulation and walnut shell filtration were applied in the pre-treatment, the permeate conductivity only increased to ˜85 μS/cm (FIG. 16, right axis, square data points) and no increase of water (vapor) flux was observed during the course of the experiment (FIG. 16, left axis, circular data points). Therefore, a vast improvement in salt rejection by membrane distillation was achieved via pretreatment using coagulation and walnut shell filtration, which effectively mitigated membrane wetting in membrane distillation treatment of unconventional oil and gas wastewater.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims.

Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method for purifying a contaminated aqueous solution to form a purified aqueous solution; the contaminated aqueous solution comprising a particulate contaminant, an inorganic contaminant, an organic contaminant, or a combination thereof; and the method comprising:
subjecting the contaminated aqueous solution to a first pretreatment comprising coagulation or precipitative softening to form an initial partially purified aqueous solution;
wherein, when the first pretreatment comprises coagulation, subjecting the contaminated aqueous solution to the first pretreatment comprises:
contacting the contaminated aqueous solution with a coagulant to cause at least a first portion of the particulate contaminant, at least a first portion of the inorganic contaminant, at least a first portion of the organic contaminant, or a combination thereof to coagulate,
thereby forming a coagulated phase and a supernatant;
separating the supernatant from the coagulated phase; and
collecting the supernatant;
wherein the supernatant is the initial partially purified aqueous solution; and
wherein, when the first pretreatment comprises precipitative softening, subjecting the contaminated aqueous solution to the first pretreatment comprises:
contacting the contaminated aqueous solution with an acid or a base to adjust the pH of the contaminated aqueous solution, thereby forming a pH adjusted contaminated aqueous solution;
contacting the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant;
separating the supernatant from the coagulated phase; and
collecting the supernatant;
wherein the supernatant is the initial partially purified aqueous solution;
subjecting the initial partially purified aqueous solution to a second pretreatment comprising adsorptive filtration to form an intermediate partially purified aqueous solution;
wherein subjecting the initial partially purified aqueous solution to the second pretreatment comprises:
introducing the initial partially purified aqueous solution as an influent to a filter column packed with an adsorbent filter media such that the initial partially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and
collecting an effluent from the filter column, wherein the effluent is the intermediate partially purified aqueous solution; and
subjecting the intermediate partially purified aqueous solution to membrane distillation to form the purified aqueous solution;
wherein subjecting the intermediate partially purified aqueous solution to membrane distillation comprises:
distilling the intermediate partially purified aqueous solution through a porous distillation membrane thereby producing a distillate; and
collecting the distillate;
wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and
wherein the distillate is the purified aqueous solution.

2. The method of claim 1, wherein the contaminated aqueous solution comprises unconventional oil wastewater, unconventional gas wastewater, conventional oil wastewater, conventional gas wastewater, or a combination thereof.

3. The method of claim 1, wherein the contaminated aqueous solution comprises shale oil wastewater, shale gas wastewater, or a combination thereof.

4. The method of claim 1, wherein the contaminated aqueous solution has a total dissolved solids content of from 0 mg/L to 400,000 mg/L.

5. The method of claim 1, wherein the coagulant comprises ferric chloride, ferric sulfate, aluminum sulfate, aluminum chloride, polyaluminum chloride, aluminum chlorohydrate, or a combination thereof.

6. The method of claim 1, wherein the contaminated aqueous solution has a turbidity, the initial purified aqueous solution has a turbidity, and the turbidity of the initial purified aqueous solution is lower than the turbidity of the contaminated aqueous solution by 90% or more.

7. The method of claim 1, wherein the contaminated aqueous solution comprises an inorganic contaminant comprising aluminum, barium, calcium, or a combination thereof and the first portion of the inorganic contaminant removed by the first pretreatment comprises 40% or more of the aluminum, barium, calcium, or a combination thereof.

8. The method of claim 1, wherein the contaminated aqueous solution comprises an organic contaminant such that the contaminated aqueous solution has a total organic carbon content, a total recoverable petroleum hydrocarbon content, an ethyl benzene content, a total xylene content, or a combination thereof; and wherein the first portion of the organic contaminant removed by the first pretreatment is 30% or more of the total organic carbon content, the total recoverable petroleum hydrocarbon content, the ethyl benzene content, the total xylene content, or a combination thereof.

9. The method of claim 1, wherein the adsorbent filter media comprises a plurality of particles comprising walnut shells.

10. The method of claim 1, wherein the initial partially purified aqueous solution comprises an organic contaminant comprising benzene, ethylbenzene, toluene, and xylenes, such that the initial partially purified aqueous solution has a total BTEX concentration; wherein the total BTEX concentration is the total concentration of benzene, ethylbenzene, toluene, and xylenes; and wherein the second portion of the organic contaminant removed by the second pretreatment comprises 90% or more of the total BTEX concentration.

11. The method of claim 1, wherein the initial partially purified aqueous solution comprises an inorganic contaminant comprising boron, and the second portion of the inorganic contaminant removed by the second pretreatment comprises 60% or more of the boron.

12. The method of claim 1, wherein the initial partially purified aqueous solution comprises an organic contaminant comprising volatile petroleum hydrocarbons, recoverable petroleum hydrocarbons, or a combination thereof; such that the initial partially purified aqueous solution has a total volatile petroleum hydrocarbon concentration and/or total recoverable petroleum hydrocarbon concentration; and wherein the second portion of the organic contaminant removed by the second pretreatment comprises 90% or more of the total volatile petroleum hydrocarbon concentration; 70% or more of the total recoverable petroleum hydrocarbon concentration; or a combination thereof.

13. The method of claim 1, wherein water flux across the porous distillation membrane decreases by 20% or less over the course of the membrane distillation.

14. The method of claim 1, wherein the porous distillation membrane exhibits a salt rejection of 99% or more over the course of the membrane distillation.

15. The method of claim 1, wherein the contaminated aqueous solution comprises an inorganic contaminant comprising boron, such that the contaminated aqueous solution has a boron content, and the sum of the first portion of the inorganic contaminant removed by the first pretreatment, the second portion of the inorganic contaminant removed by the second pretreatment, and the third portion of the inorganic contaminant removed by the membrane distillation comprises 99% or more of the boron content.

16. The method of claim 1, wherein the contaminated aqueous solution comprises an organic contaminant comprising benzene, ethylbenzene, toluene, and xylenes, such that the contaminated aqueous solution has a total BTEX concentration; wherein the total BTEX concentration is the total concentration of benzene, ethylbenzene, toluene, and xylenes; and wherein the sum of the first portion of the organic contaminant removed by the first pretreatment, the second portion of the organic contaminant removed by the second pretreatment, and the third portion of the organic contaminant removed by the membrane distillation comprises 95% or more of the total BTEX concentration.

17. The method of claim 1, wherein the purified aqueous solution has a boron concentration of 0.5 mg/L or less; a total BTEX concentration of 100 μg/L or less; a total recoverable petroleum hydrocarbon concentration of 5 mg/L or less; a total volatile petroleum hydrocarbon concentration of 1 mg/L or less; or a combination thereof.

18. The method of claim 1, wherein the method further comprises purifying a second contaminated aqueous solution to form a second purified aqueous solution and wherein the method further comprises cleaning the porous distillation membrane before purifying the second contaminated aqueous solution and using the cleaned porous distillation membrane to form the second purified aqueous solution.

19. A system for purifying a contaminated aqueous solution to form a purified aqueous solution; the contaminated aqueous solution comprising a particulate contaminant, an inorganic contaminant, an organic contaminant, or a combination thereof; and the system comprising:
a first pretreatment component configured to receive a contaminated aqueous solution and subject the contaminated aqueous solution to a first pretreatment comprising coagulation or precipitative softening to form an initial partially purified aqueous solution;
wherein, when the first pretreatment comprises coagulation, the first pretreatment component is configured to:
contact the contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant;
separate the supernatant from the coagulated phase; and
collect the supernatant;
wherein the supernatant is the initial partially purified aqueous solution;
wherein, when the first pretreatment comprises precipitative softening, the first pretreatment component is configured to:
contact the contaminated aqueous solution with an acid or a base to adjust the pH of the contaminated aqueous solution, thereby forming a pH adjusted contaminated aqueous solution;
contact the pH adjusted contaminated aqueous solution with a coagulant to cause at least a first portion of the particulate contaminant, at least a first portion of the inorganic contaminant, at least a first portion of the organic contaminant, or a combination thereof to coagulate, thereby forming a coagulated phase and a supernatant;
separate the supernatant from the coagulated phase; and
collect the supernatant;
wherein the supernatant is the initial partially purified aqueous solution;
a second pretreatment component fluidly connected to the first pretreatment component, wherein the second pretreatment component is configured to receive the initial partially purified aqueous solution from the first pretreatment component and subject the initial partially purified aqueous solution to a second pretreatment comprising adsorptive filtration to form an intermediate partially purified aqueous solution;
wherein the second pretreatment component is configured to:
introduce the initial partially purified aqueous solution as an influent to a filter column packed with an adsorbent filter media such that the initially purified aqueous solution contacts the adsorbent filter media, wherein the adsorbent filter media removes at least a second portion of the particulate contaminant, at least a second portion of the inorganic contaminant, at least a second portion of the organic contaminant, or a combination thereof; and
collect an effluent from the filter column, wherein the effluent is the intermediate partially purified aqueous solution; and
a membrane distillation component fluidly connected to the second pretreatment component, wherein the membrane distillation component is configured to receive the intermediate partially purified aqueous solution from the second pretreatment component and subject the intermediate partially purified aqueous solution to membrane distillation to form the purified aqueous solution;
wherein the membrane distillation component is configured to:
distill the intermediate partially purified aqueous solution through a porous distillation membrane thereby producing a distillate; and
collect the distillate;
wherein distilling the intermediate partially purified aqueous solution through the porous distillation membrane removes at least a third portion of the particulate contaminant, at least a third portion of the inorganic contaminant, at least a third portion of the organic contaminant, or a combination thereof from the distillate; and
wherein the distillate is the purified aqueous solution.

20. The system of claim 19, wherein the system is configured as an onsite and/or mobile wastewater treatment system.
